(19) United States
(12) Patent Application Publication
(10) Pub. No.: US 2026/0175347 A1
(43) Pub. Date: Jun. 25, 2026

(54) WORKING MACHINE

(71) Applicant: KoKi Holdings Co., Ltd., Tokyo (JP)

(72) Inventors: Kentaro HATAKEYAMA, Ibaraki (JP); Shingo KOSUGI, Ibaraki (JP)

(73) Assignee: Koki Holdings Co., Ltd., Tokyo (JP)

(21) Appl. No.: 18/870,574

(22) PCT Filed: May 26, 2023
(86) PCT No.: PCT/JP2023/019604

§ 371 Date: Sep. 8, 2025

(30) Foreign Application Priority Data
May 31, 2022 (JP) 2022-089217

(51) Int. Cl. B24B 23/00; B24B 23/02; B24B 47/12; F21V 33/00

(52) U.S. Cl. CPC B24B 23/005; B24B 23/02; B24B 47/12; F21V 33/0084

(57) ABSTRACT

The present invention provides a working machine with a good lighting device. In a grinder, the lighting device is provided on both left and right sides of rear end of a gear housing and above wheel guard. Specifically, a holder of the lighting device is visibly exposed from an outer periphery of the gear housing in front view. When an LED of the lighting device emits light by an operator's operation of an operating portion, emitted light illuminates a lower portion of a spindle (i.e., a grinding wheel). In other words, a housing does not block the light emitted toward the grinding wheel from the lighting device on both sides of the housing, and the light can illuminate the grinding wheel disposed around the lower portion of the spindle. Therefore, the lower portion of the spindle (i.e., the grinding wheel) can be well illuminated.

### BACKGROUND OF THE INVENTION

### Field of Invention

The present invention relates to a working machine.

### Description of Related Art

In a grinder (working machine) described in Patent Literature 1 below, a motor is housed inside a motor housing extending in front-back direction, and a spindle is housed inside a gear housing disposed at front of the motor housing. A tip tool such as a grinding wheel is mounted to a lower end of the spindle, and the tip tool is partially covered by a wheel guard. When the motor is driven, the grinding wheel rotates with the spindle to apply polishing or other processing to a material to be processed.

### RELATED ART LITERATURE

### Patent Literature

### [Patent Literature 1]

Japanese Unexamined Patent Application Publication No. 2021-160045.

### SUMMARY OF THE INVENTION

### Disclosure of Invention

### Problem to be Solved by Invention

In the working machine such as the above grinder, workability can be improved by lighting an area around a lower portion of the spindle (tip tool) with a lighting device. However, the working machine such as the above grinder may be placed on a flat surface such as a ground, and the lighting device may be damaged or deformed by the ground depending on a location of the lighting device. In addition, depending on the location of the lighting device, it may be difficult to illuminate the area around the lower portion of the spindle since the spindle and the wheel guard may block the light. Therefore, it is desirable for the working machines to have a good lighting device.

In view of the above facts, the present invention aims to provide the working machine with the good lighting device.

### Means to Solve Problem

At least one embodiment of the present invention is a working machine comprising: a motor that rotates with front-back direction as its axis; a housing with a motor housing that houses the motor and a gear housing that is disposed on front of the motor housing; a spindle supported by the gear housing, extending in up-down direction, rotating by transmission of a driving force of the motor, and to which a disc-shaped tip tool is removably attached at a lower portion; a guard member attached to the gear housing and covering at least a portion of the tip tool; and a lighting device that is at least partially provided above the guard member and on at least one of left and right sides of the housing, and that extends from inside of the motor housing, and irradiates light around the lower portion of the spindle so that the light passes through outside of the gear housing.

At least one embodiment of the present invention is a working machine comprising: a motor that rotates with front-back direction as its axis; a housing with a motor housing that houses the motor and a gear housing that is disposed on front of the motor housing; a spindle supported by the gear housing, extending in up-down direction, rotating by transmission of a driving force of the motor, and to which a disc-shaped tip tool is removably attached at a lower portion; a guard member attached to the gear housing and covering at least a portion of the tip tool; and a lighting device that is provided lower than an axis of the motor and illuminates an area around the lower portion of the spindle; wherein, the lighting device is at least partially provided above the guard member and on at least one of left and right sides of the housing, and the lighting device is visible from the front of the housing through a space created by a forward opening or a left-right recess set in the housing.

At least one embodiment of the present invention is the working machine, wherein the working machine comprises a protection mechanism that prevents contact between a flat surface such as a ground or a floor and the lighting device when the lighting device is brought close to the flat surface in left-right direction.

At least one embodiment of the present invention is the working machine, wherein the lighting device is configured to be visible when viewed from the front, and the protection mechanism is configured to protrude the outside of the housing than the lighting device.

At least one embodiment of the present invention is the working machine, wherein the protection mechanism comprises: a front protector disposed adjacent to the front of the lighting device; and a rear protector disposed at rear of the lighting device; wherein viewed from the front of the housing, the lighting device is partially disposed adjacent to lower side of the front protector.

At least one embodiment of the present invention is the working machine, wherein the lighting device is positioned above than the tip tool and behind and outside in left-right direction than the spindle.

At least one embodiment of the present invention is the working machine, wherein the lighting device is visibly exposed from an outer circumference of left and right sides of the gear housing.

At least one embodiment of the present invention is the working machine, wherein the lighting device comprises: a light emitter having a light source; and a holder holding the light emitter, wherein a rear portion of the holder is connected to the motor housing or an inner member housed in the motor housing, and a front portion of the holder is connected to the gear housing.

At least one embodiment of the present invention is the working machine, wherein the rear portion of the holder is assembled to the inner member which is assembled to the motor, and the holder is sandwiched in the front-back direction by the gear housing and the motor housing.

At least one embodiment of the present invention is a working machine comprising: a first housing extending in front-back direction and having an opening at a front end that is open to front and houses a motor; a second housing provided in the front of the first housing, supporting a spindle holding a tip tool and connected to the first housing to cover the opening; and a lighting device that is partially positioned in the first housing and partially extended forward through the opening to irradiate light around the tip tool, wherein the opening is at least partially covered by the second housing and at least a portion of the portion not covered by the second housing is covered by the lighting device.

At least one embodiment of the present invention is the working machine, wherein the lighting device comprises a light emitter having a light source, and a connecting portion connecting a power supply supplying power to the light source and the light source, wherein the light emitter is disposed outside of the first housing.

At least one embodiment of the present invention is the working machine, wherein the lighting device has a holder that holds the light emitter and the connecting portion, wherein the holder holds the light emitter at a position forward than the spindle.

At least one embodiment of the present invention is the working machine, wherein the holder is disposed to surround the spindle and comprises a first holder that holds the light emitter and the connecting portion, and a second holder that holds the connecting portion, wherein a rear portion of the second holder is housed inside the first housing, and a front portion of the second holder protrudes forward through the opening and is sandwiched front to back by the first housing and the second housing.

At least one embodiment of the present invention is the working machine, wherein the first holder is disposed radially outward of the spindle with respect to a lower end of the second housing and above the tip tool, wherein the light source overlaps the second housing when viewed from the top.

At least one embodiment of the present invention is the working machine, wherein the second housing is configured with at least two or more split members, wherein the first holder is fixed to the second housing by a fixture that fixes the split members together.

### Advantage of Present Invention

According to one or more embodiments of the invention, the working machine with the good lighting device can be provided.

### BRIEF DESCRIPTION OF THE DRAWINGS

FIG. 1 is a side view from left illustrating a disk grinder according to a first embodiment.

FIG. 2 is a side cross-sectional view from the left illustrating inside of the disk grinder illustrated in FIG. 1.

FIG. 3 is a front view from front of the disk grinder illustrated in FIG. 1.

FIG. 4 is a plan view of a front portion of the disk grinder illustrated in FIG. 1 viewed from top.

FIG. 5 is the side view from the left illustrating a holder of a lighting device illustrated in FIG. 1 removed from a gear housing and a fan guide.

FIG. 6 is an oblique forward view from left diagonally forward of the holder and the fan guide illustrated in FIG. 5.

FIG. 7 is an oblique rear view from left diagonally rear of the holder, the gear housing, and the fan guide illustrated in FIG. 5.

FIG. 8 is a cross-sectional view from the left illustrating a assembled state of the lighting device to the gear housing and the fan guide illustrated in FIG. 3 (enlarged cross-sectional view of an 8-8 line in FIG. 3).

FIG. 9 illustrates the lighting device on the left illustrated in FIG. 1.

FIG. 10 is the cross-sectional view from the top illustrating a protection mechanism on the left illustrated in FIG. 1 (line 10-10 cross section of FIG. 1).

FIG. 11 illustrates variation 1 of an arrangement of the lighting device illustrated in FIG. 1.

FIG. 12 illustrates variation 2 of the arrangement of the lighting device illustrated in FIG. 1.

FIG. 13 illustrates variation 3 of the arrangement of the lighting device illustrated in FIG. 1.

FIG. 14 illustrates variation 4 of the arrangement of the lighting device illustrated in FIG. 1.

FIG. 15 is the side view from the left of variation 4 of the arrangement of the lighting device illustrated in FIG. 14.

FIG. 16 is an enlarged front view of a lower portion in a front portion of a disk grinder according to a second embodiment.

FIG. 17 is a side view from left of the front portion of the disk grinder illustrated in FIG. 16.

FIG. 18 is a cross-sectional view from below illustrating a fixed state of a lighting device to a gear housing illustrated in FIG. 16 (cross-sectional view of the 18-18 line in FIG. 16).

FIG. 19 is the cross-sectional view from the left illustrating the fixed state of the lighting device to the gear housing illustrated in FIG. 16 (cross-sectional view of the 19-19 line in FIG. 16).

FIG. 20 is an oblique view of the lighting device illustrated in FIG. 16, viewed from left diagonally forward, illustrating a holder cover removed from a transparent holder.

### DETAILED DESCRIPTION OF THE INVENTION

### First Embodiment

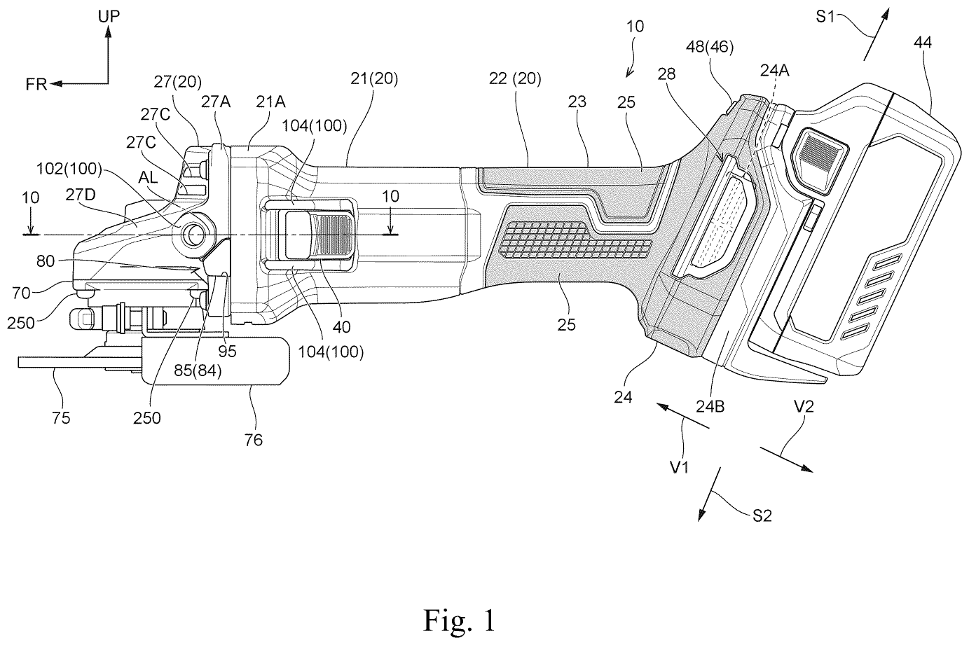

A disk grinder 10 (hereinafter simply referred to as “grinder 10”) as a working machine according to a first embodiment will be described below using FIG. 1 to FIG. 10. Arrows UP, FR, and LH illustrated in drawings as appropriate indicate upper, front, and left sides of the grinder 10, respectively. In the following description, when directions up-down, front-back, and left-right are used, they will indicate vertical, front and back, and left and right directions of the grinder 10, unless otherwise noted.

As illustrated in FIG. 1 to FIG. 4, the grinder 10 is configured as a tool that performs polishing or other processing on a material to be processed using a grinding wheel 75 or the like as a tip tool. The grinder 10 also has a pair of left and right lighting devices 80 that illuminate an area around the grinding wheel 75, and a protection mechanism 100 for protecting the lighting devices 80. An overall configuration of grinder will be described first, followed by descriptions of the lighting device 80 and the protection mechanism 100.

### Overall Configuration of Grinder 10

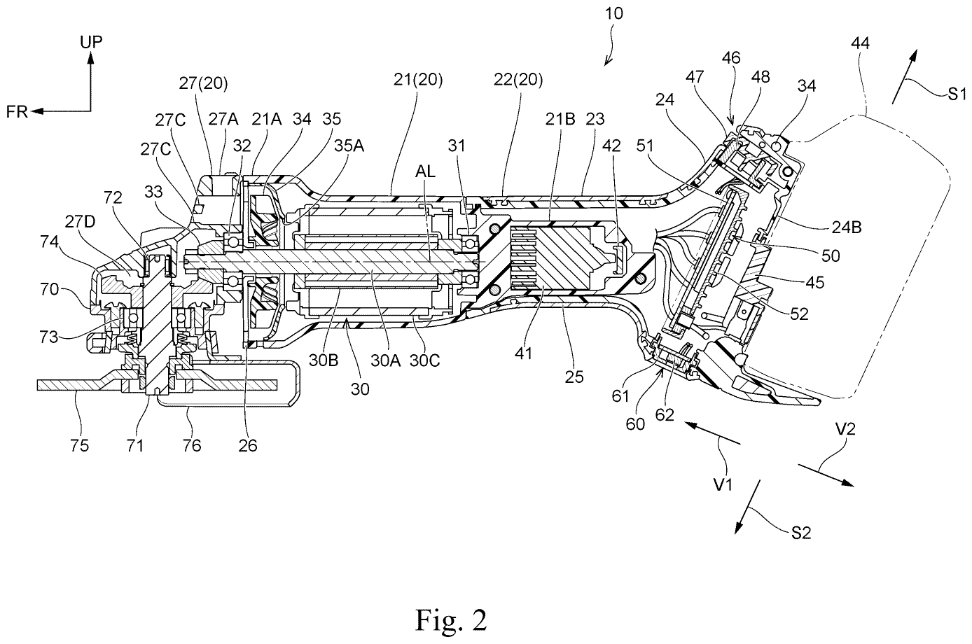

As illustrated in FIG. 1 and FIG. 2, the grinder 10 is formed in a substantially cylindrical shape extending in front-back direction as a whole, and an outline of the grinder is configured with a housing 20. The housing 20 comprises a motor housing 21 comprising a middle of the housing 20 in the front-back direction, a handle housing 22 comprising a rear portion of the housing 20, and a gear housing 27 comprising a front end of the housing 20.

### Motor Housing 21

The motor housing 21 is made of resin and is formed as a substantially bottomed cylindrical shape open to front. A motor 30 is housed in the motor housing 21. The motor 30 is electrically connected to a controller 50, which is described further below, and is driven under a control of the controller 50. The motor 30 comprises a rotating shaft 30A, a rotor 30B, and a stator 30C. The motor 30 is a brushless motor, and resin insulators are provided in front and back of the stator 30C.

The rotating shaft 30A is disposed with the front-back direction as axial direction, and a rear end of the rotating shaft 30A is rotatably supported by a first motor bearing 31 held in a rear wall of the motor housing 21. The front end of the rotating shaft 30A is disposed in the gear housing 27, described further below, and the front end of the rotating shaft 30A is rotatably supported by a second motor bearing 32 held in the gear housing 27. A pinion gear 33 is fixed to the front end of the rotating shaft 30A. The rotor 30B is disposed in a radial direction outside of the rotating shaft 30A and is configured to rotate integrally with the rotating shaft 30A. The stator 30C is formed in the substantially cylindrical shape with the front-back direction as the axial direction and is supported by the motor housing 21 in the radial direction outside of the rotor 30B.

A fan 34 is provided integrally rotatable in the front end of the rotating shaft 30A behind the second motor bearing 32. The fan 34 is configured as a centrifugal fan, and the fan 34 is configured to generate airflow from rear to the front.

A fan guide 35 as an inner member is provided on the radial direction outside of the fan 34. The fan guide 35 is formed in a substantially bottom cylindrical shape open to the front, and an insertion 35A is formed through a center of a bottom wall of the fan guide 35, and the rotating shaft 30A of the motor 30 is inserted through the insertion 35A. The fan guide 35 is assembled at a tip of the stator 30C of the motor 30 and is sandwiched in the front-back direction by the gear housing 27 described further below, and the motor 30. The fan guide 35 guides the airflow forward, that is directed radially outward by the fan 34. Air guided forward by the fan guide 35 is exhausted to outside through an exhaust port 27C described further below.

At the front end of the motor housing 21, a diameter—expanded portion 21A is formed as an opening that extends outward in the radial direction. The diameter—expanded portion 21A is formed in a substantially rectangular shape in a front view and also in the substantially rectangular shape with up-down direction as longitudinal direction, viewed from left, and is open to the front. A switch lever 40 (see FIG. 1) is provided on a left portion of the motor housing 21. The switch lever 40 is connected to the motor housing 21 slidable in the front-back direction. Specifically, the switch lever 40 is configured to be slidable between an OFF position illustrated in FIG. 1 and an ON position (not illustrated), slid forward from the OFF position.

The rear wall of the motor housing 21 is integrally provided with a switch holder 21B. The switch holder 21B protrudes rearward from the motor housing 21 and is open to right, forming a substantially rectangular box shape. A switch 41 is held in the switch holder 21B. The switch 41 is electrically connected to the controller 50 described further below, and when the above-mentioned switch lever 40 is operated from the OFF position to the ON position, the switch 41 is turned on and outputs an ON signal to the controller 50. Specifically, a slide bar 42 is connected to the switch lever 40, and when the switch lever 40 is slid, the slide bar 42 presses the switch 41. As a result, the switch 41 is turned on and the motor 30 is driven by the controller 50. The slide bar 42 extends in the front-back direction in the housing 20, and only the rear end of the slide bar 42 is illustrated in FIG. 2.

### Handle Housing 22

The handle housing 22 is made of resin and comprises housing members divided into two parts in left-right direction. The housing members of the handle housing 22 are fastened to each other with the switch holder 21B sandwiched between them from both sides in the left-right direction. As a result, the handle housing 22 is coupled to the motor housing 21. A front portion of the handle housing 22 is configured as a handle 23 to be grasped by an operator, and the rear portion of the handle housing 22 is configured as a rear housing 24. The rear housing 24 protrudes further than the handle 23 to both sides in the up-down and left-right directions. In other words, a width dimension (dimension in the left-right direction) of the rear housing 24 is set larger than the width dimension of the handle 23.

The rear housing 24 extends in direction that slopes rearward toward upper side when viewed from the left-right direction. In the following description, the direction of extension of the rear housing 24 is referred to as inclined direction (see arrows S1 and S2 in FIG. 1 and FIG. 2), and the direction orthogonal to the inclined direction is referred to as orthogonal direction (see arrows V1 and V2 in FIG. 1 and FIG. 2), when viewed from the left-right direction. The side in the direction of the arrow S1 in FIG. 1 and FIG. 2 is referred to as one side in the inclined direction, and the side in the direction of the arrow V1 in FIG. 1 and FIG. 2 is referred to as said one side in the orthogonal direction.

Several air intake ports 24A (see FIG. 1) are formed through left and right side walls of the rear housing 24. The air intake ports 24A are formed in a form of long holes with the inclined direction as the longitudinal direction. In the rear housing 24, a left-right pair of filters 28 are removably provided at positions corresponding to the air intake ports 24A, and the filters 28 cover the air intake ports 24A from the outside in the left-right direction. This prevents foreign matter from entering the housing 20 through the intake ports 24A by means of the filters 28. Most of an outer periphery of the handle housing 22 is covered by a rubber 25 (see a grayed-out portion in FIG. 1) made of an elastic material such as rubber or elastomer, and the rubber 25 is integrally formed with the handle housing 22.

The rear housing 24 houses the controller 50. The controller 50 comprises a controller board 51 and a controller case 52 that houses and holds the controller board 51. The controller case 52 is open to said one side in the orthogonal direction and is formed in a shape of a box with a relatively shallow bottom, and is sandwiched between the handle housing 22 from the outside in the left-right direction. The controller board 51 is formed in a substantially rectangular plate shape with the orthogonal direction as thickness direction, and is disposed in and held by the controller case 52. The controller 50 is disposed between left and right air intake ports 24A. As a result, when the fan 34 rotates, the airflow is generated from the air intake ports 24A into the handle housing 22, and the airflow passes through the holes (not illustrated) formed in the rear wall of the motor housing 21 and flows to the front in the motor housing 21 to cool the controller 50 and the motor 30.

The rear end of the rear housing 24 has a battery attacher 24B for attaching a battery 44 on other side in the orthogonal direction of the controller 50. The battery attacher 24B extends along the inclined direction. The battery attacher 24B is formed in a concave shape open to said one side in the inclined direction and to the other side in the orthogonal direction. The battery attacher 24B has a terminal unit 45 that is connected to the battery 44. The terminal unit 45 is sandwiched from the outside in the left-right direction by the handle housing 22 and assembled to the handle housing 22. The terminal unit 45 is electrically connected to the controller 50. The battery 44 as a power supply is removably attached to the battery attacher 24B from said one side in the inclined direction, and a power from the battery 44 is supplied to the controller 50 via the terminal unit 45.

At an upper end of the rear housing 24, on said one side in the inclined direction of the controller 50, a speed setting part 46 is provided. The speed setting part 46 is configured as a mechanism for setting a target rotation speed of the motor 30. The speed setting part 46 comprises a rotary volume 47 and an operation dial 48. The operation dial 48 is formed in a disk-shape with substantially inclined direction as the thickness direction, and is configured to be rotatable with the substantially inclined direction as the axial direction. The operation dial 48 is operably exposed from the rear housing 24 in said one side in the orthogonal direction partially. The rotary volume 47 is configured as a rotary variable resistor and is electrically connected to the controller 50. The rotary volume 47 is coupled to the operation dial 48 and outputs an output signal to the controller 50 according to a rotational position of the operation dial 48, and a rotation speed of the rotating shaft 30A of the motor 30 is set by the controller 50.

At a lower end of the rear housing 24, on the other side in the inclined direction of the controller 50, an operating portion 60 is provided. The operating portion 60 is configured as the mechanism for operating the lighting device 80, which is described further below. The operating portion 60 comprises an operation button 61 and an operation switch 62. The operation button 61 is exposed from the outer periphery of the rear housing 24 so as to be pressure-operable. The operation switch 62 is configured with a tactile switch or the like and is electrically connected to the controller 50. When the operation button 61 is operated by pressing and the operation switch 62 is turned on, the ON signal is output from the operation switch 62 to the controller 50.

### Gear Housing 27

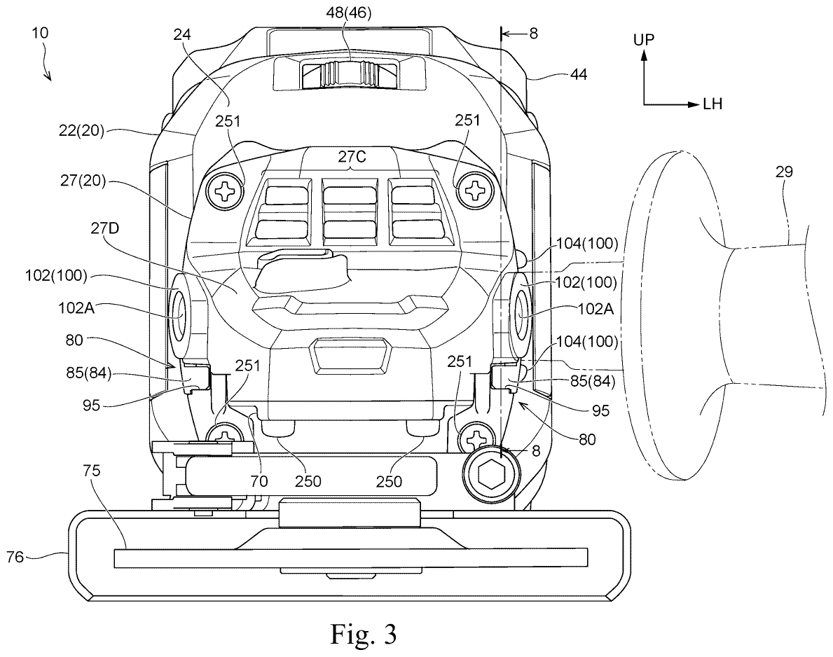

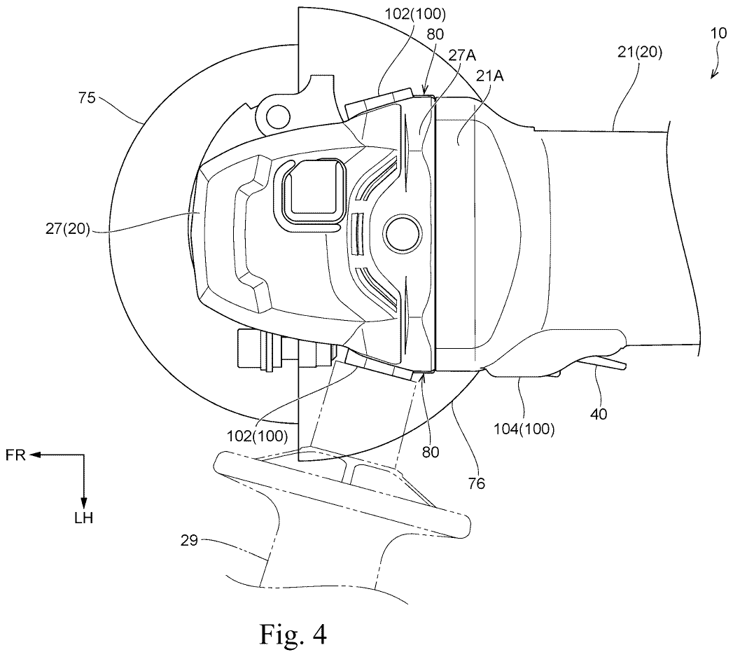

As illustrated in FIG. 3 and FIG. 4, the gear housing 27 is formed in a hollow shape forming a substantially triangular shape when viewed from the left-right direction, and is open to lower and rear sides. At the rear end of the gear housing 27, a coupling 27A is formed. The coupling 27A is formed in a substantially rectangular cylindrical shape corresponding to the diameter—expanded portion 21A of the motor housing 21. The coupling 27A and the diameter—expanded portion 21A are butted together in the front-back direction, and the outer circumference of the coupling 27A is fastened and secured to the diameter—expanded portion 21A. A packing gland 70 is provided below the gear housing 27. In other words, an open portion of the gear housing 27 to the lower side is closed (covered) by the packing gland 70. The packing gland 70 is formed as a two-step stepped cylindrical shape with the up-down direction as the axial direction, and is fixed to gear housing 27. Specifically, in the packing gland 70, an outer diameter of the upper end is set larger than the outer diameter of the middle in the up-down direction, and the outer diameter of the middle in the up-down direction is larger than the outer diameter of the lower end. The packing gland 70 is fixed to gear housing 27 by a fixing screw 250. A retainer 26 is provided on the rear of gear housing 27. In other words, the open portion of the gear housing 27 to the rear is closed (covered) by the retainer 26. The retainer 26 may cover the entire rearward open portion of the gear housing 27, or it may cover only the portion. The retainer 26 is a metal plate member that serves to hold and position the second motor bearing 32 held in the gear housing 27 from the rear. The retainer 26 has a circular through-hole in its center through which the rotating shaft 30A is inserted. The top and bottom of the retainer 26 are provided with air holes through which the airflow from the fan 34 passes. The retainer 26 may or may not be fixed to the gear housing 27. An exhaust port 27C is provided at the top of the gear housing 27. A lower rear portion of the gear housing 27 (especially the center in the left-right direction) does not cover the motor housing 21 (retainer 26). This creates a space at the lower rear portion of the gear housing 27 through which the airflow from the fan 34 sent from the motor housing 21 passes. It will be acceptable the lower rear portion of the gear housing 27 does not have the space for the airflow to pass through. The gear housing 27 has at least two spaces inside: a transmission mechanism housing space that houses a reduction mechanism (transmission mechanism including the pinion gear 33 and a bevel gear 74 described further below), and a ventilation space that communicate with the exhaust port 27C through which the airflow from the fan 34 passes. A handle mounting portion 102 (see further below for details) to which a side handle 29 can be attached, is provided at the rear portion of the gear housing 27. The gear housing in the present invention may include the packing gland 70. The gear housing in the present invention may also include the retainer 26.

The gear housing 27 has an accommodating portion 27D. The accommodating portion 27D is the portion that accommodates the bevel gear 74. A spindle 71 is provided inside the accommodating portion 27D. The spindle 71 is formed in the substantially cylindrical shape with the up-down direction as the axial direction. The upper end of the spindle 71 is rotatably supported by a bearing 72 fixed to the gear housing 27, and the middle of spindle 71 in the up-down direction is rotatably supported by a bearing 73 fixed to the packing gland 70. An upper end portion of the spindle 71 is provided with the bevel gear 74 that can rotate integrally, and the pinion gear 33 of the motor 30 is meshed with the bevel gear 74. As a result, a driving force of the motor 30 is transmitted to the spindle 71 by the bevel gear 74. The grinding wheel 75 as the tip tool is mounted on the lower end of the spindle 71. The grinding wheel 75 is formed in a substantially disc shape with the up-down direction as the thickness direction. As a result, the driving force of the motor 30 causes the grinding wheel 75 to rotate together with the spindle 71 to perform polishing or other processing on the material to be processed. In other words, the spindle 71 and the bevel gear 74 are configured as the transmission mechanism that transmits the driving force of motor 30 to grinding wheel 75. A wheel guard 76 as a guard member is removably fixed to the lower end of the packing gland 70. The wheel guard 76 covers the rear portion of the grinding wheel 75 from the upper and rear sides. Specifically, the wheel guard 76 is formed in the shape of a substantially semi-disk, and the outer circumference of the wheel guard 76 is bent downward to cover the rear portion of the grinding wheel 75 from the rear side.

As illustrated in FIG. 3, fixing screw 251 that serve as fixture for fixing the gear housing 27 to the motor housing 21 is provided at the rear portion of the gear housing 27. Four fixing screws 251 are provided. As illustrated in FIG. 1 to FIG. 4, the rear portion of the gear housing 27 (the portion behind than the spindle 71) is provided with the exhaust port 27C (and an air passage space that communicates with the exhaust port 27C), the handle mounting portion 102, the fixing screws 251 (fixing structure with the motor housing 21), and at least the portion of the lighting device in the present invention. The fixing screws 251 are provided at the ends in the up-down direction and at the ends in the left-right direction. In other words, the fixing screws 251 are provided at diagonal ends (corners) of the gear housing 27, viewed in the front-back direction. The exhaust port 27C is provided at and near a center position in the left-right direction. The handle mounting portion 102 is provided near the center position in the up-down direction. The lighting device 80, described below, is provided avoiding the areas where the fixing screw 251, the exhaust port 27C (air passage), and the handle mounting portion 102 are disposed (the lighting device is supported by the gear housing 27 at an avoided position).

### Lighting Device 80

As described in detail further below, the lighting device 80 (lighting device in the present invention) includes an LED 81 that serves as a light source, a lighting circuit board 82 on which the LED 81 is loaded, a wiring 83 to supply power to the LED 81 (the lighting circuit board 82), and a holder 84 that holds the lighting circuit board 82. As illustrated in FIG. 1 and FIG. 3 to FIG. 10, at least the portion of the lighting device 80 is provided on each of the left and right sides of the housing 20. In detail, the lighting device 80 is partially disposed at the side of the housing 20 in the left-right direction and straddles a boundary between the motor housing 21 and the gear housing 27. More precisely, the holder 84 (details described further below) included in the lighting device 80 is d isposed to extend from the position overlapping the motor housing 21 to the position overlapping the gear housing 27 when viewed in the left-right direction. The front portion of the lighting device 80 is exposed for external visibility at the rear end of the gear housing 27 at the sides (left and right side surfaces). Exposed here means uncovered, and exposed from the left means that the left side of (at least the portion of) the lighting device 80 is uncovered, and exposed from the front view means that the front of (at least the portion of) the lighting device 80 is uncovered. The lighting device 80 is disposed outwardly in the left-right direction than the accommodating portion 27D. Accordingly, the lighting device 80 is disposed outward in the left-right direction than the bevel gear 74. The left and right pair of lighting devices 80 are symmetrically configured with respect to the center of the grinder 10 in the left-right direction. In other words, the lighting device 80 on the left and the lighting device 80 on the right are mirror images in shape and configuration, and the shape and features of one are the same for the mirror image portion of the other. For this reason, in the following description, the lighting device 80 on the left will be described, and the description of the lighting device 80 on the right will be omitted as appropriate.

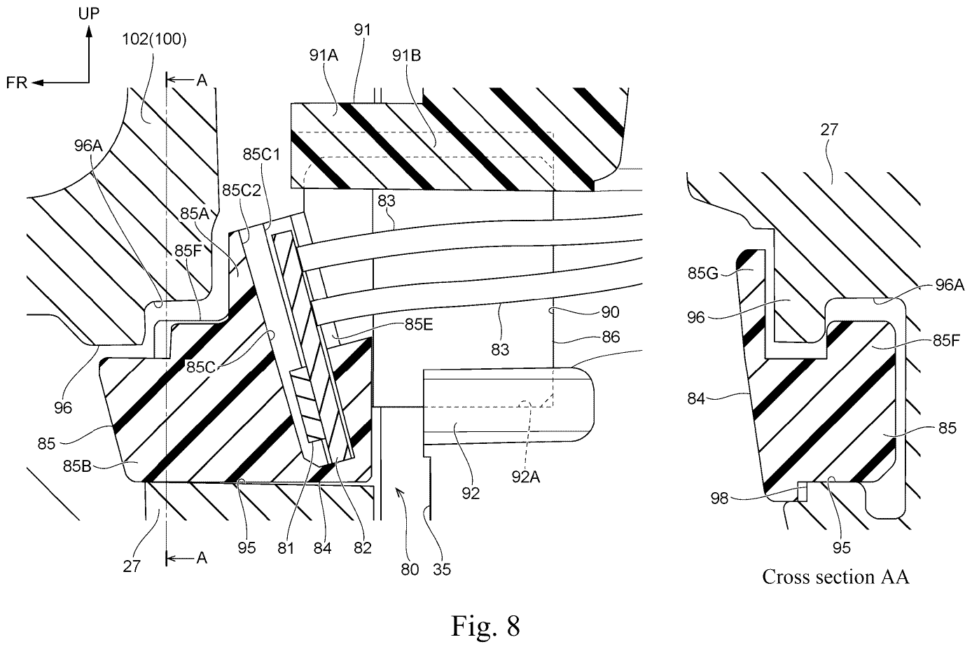

The lighting device 80 comprises the LED 81 (see FIG. 8) as the light source, the lighting circuit board 82 on which the LED 81 is implemented, and the holder 84 for holding the lighting circuit board 82. In the lighting device 80, the holder 84 is assembled to the gear housing 27 and the fan guide 35, and the front portion of the holder 84 is externally visible and exposed at both left and right sides of the rear end of the gear housing 27. For this reason, the structure of a mounter of the lighting device 80 in the gear housing 27 and fan guide 35 will be described first, followed by the description of each configuration of the lighting device 80. The LED 81 and the lighting circuit board 82 correspond to a light-emitter of the invention.

### Mounting Portion of Fan Guide 35

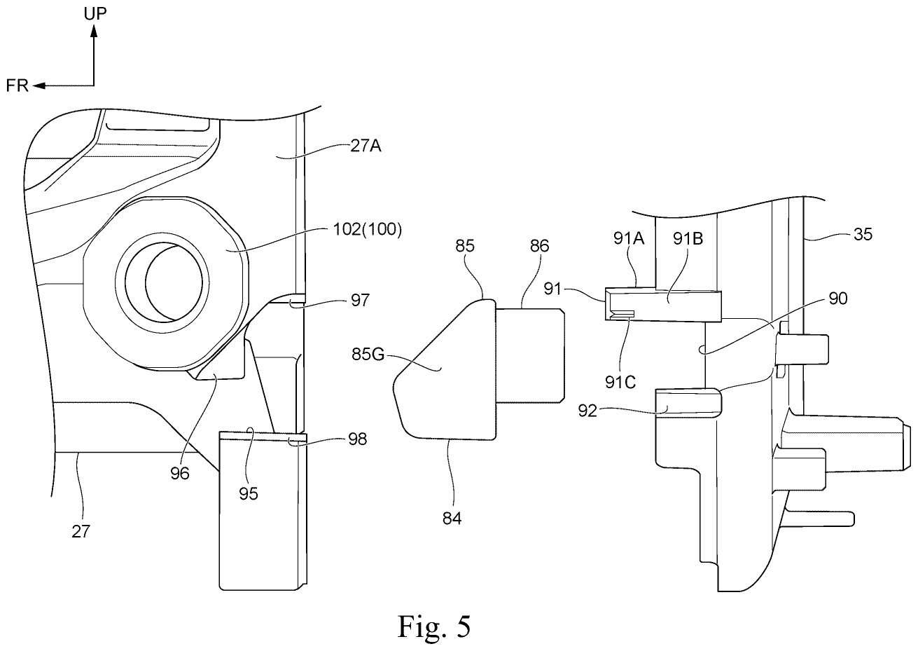

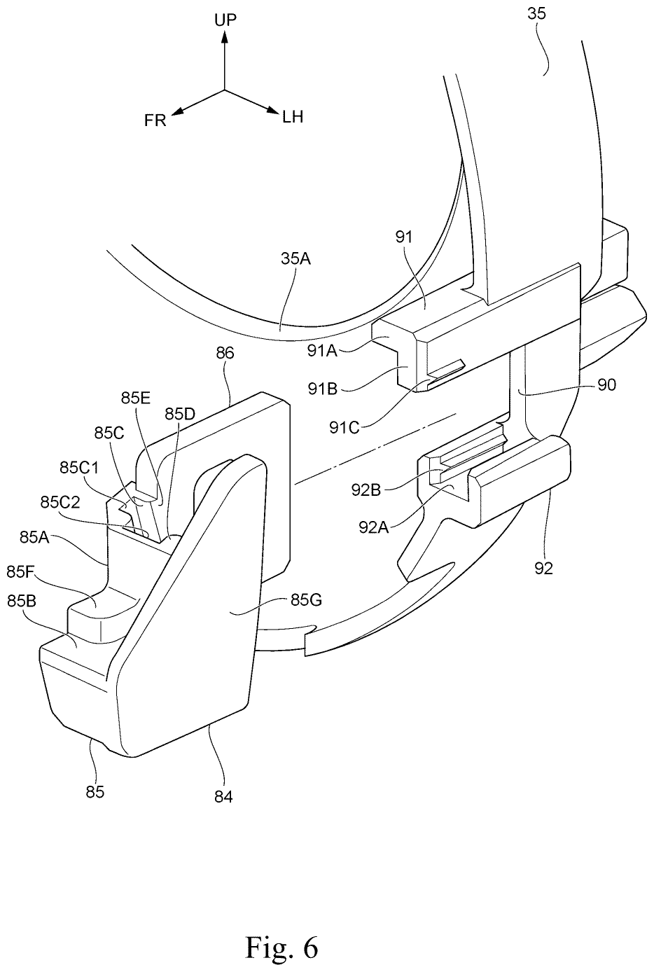

As illustrated in FIG. 5 to FIG. 8, a rear mounting portion 90 is formed on the left portion of the fan guide 35 for mounting the holder 84 of the lighting device 80. The rear mounting portion 90 is formed in the concave shape open to the front, when viewed from the left. A guide 91 is provided at the upper end of the rear mounting portion 90. The guide 91 is formed in a substantially rail shape extending in the front-back direction and in a substantially inverted L-shape viewed from the front. In detail, the guide 91 comprises an upper wall 91A and a side wall 91B extending downward from the left end of the upper wall 91A. The front portion of the guide 91 protrudes forward than the front end of the fan guide 35. Ribs 91C (see FIG. 6) are formed on each of the left and right sides of the side wall 91B. The ribs 91C extend in the front-back direction and are substantially triangular in shape in front view (in FIG. 6, only the left rib 91C is illustrated).

A mounting rail 92 is formed at the lower end of the rear mounting portion 90. The mounting rail 92 extends in the front-back direction and is formed in a substantially U-shape, open to the upper side when viewed from the front. That is, the mounting rail 92 has a rail groove 92A as a first groove that is open to the upper side and extends in the front-back direction, and the front end of the rail groove 92A is open to the front. Ribs 92B (see FIG. 6) are formed integrally on both left and right side surfaces of the rail groove 92A. The ribs 92B extend in the front-back direction and are substantially triangular in shape in front view (in FIG. 6, only the right side rib 92B is illustrated).

### Mounting Portion of Gear Housing 27

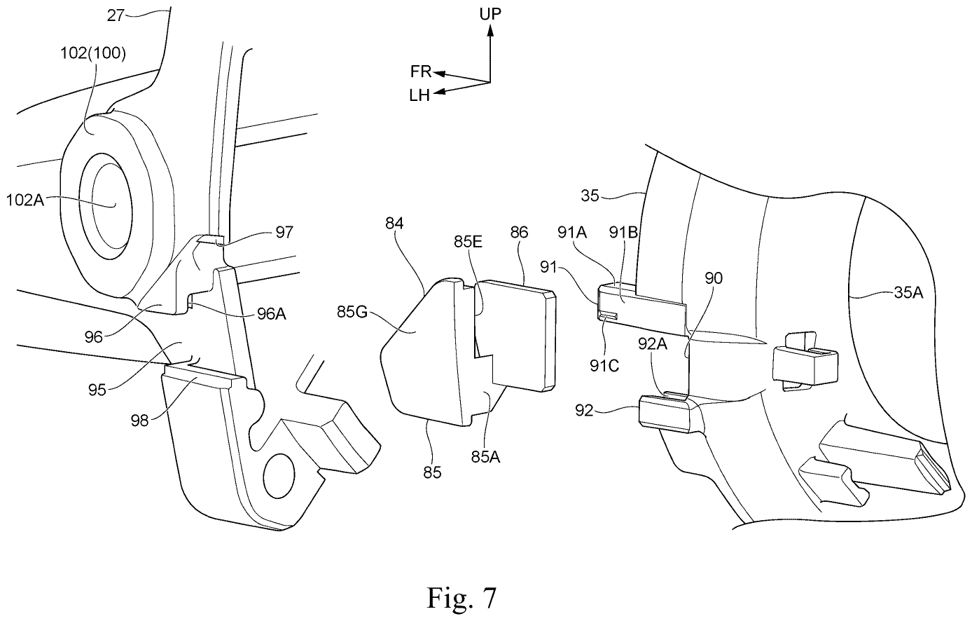

As illustrated in FIG. 1, FIG. 3, FIG. 5, FIG. 7, and FIG. 8, a front mounting portion 95 is formed on the left portion of the rear end of the gear housing 27 to mount the holder 84 of the lighting device 80 and expose the holder 84 to the outside. The front mounting portion 95 is a concave (notch) recessed inwardly in the left-right direction. More precisely, the front mounting portion 95 is formed in the form of a groove extending in the front-back direction and open to the left, and is disposed adjacent to the rear diagonally below the handle mounting portion 102 described further below. The front mounting portion 95 is penetrated in the front-back direction, and the rear end opening of the front mounting portion 95 is closed from the rear by the diameter—expanded portion 21A of the motor housing 21. The above-mentioned rear mounting portion 90 is positioned at the rear of the front mounting portion 95 when viewed from the left. An upper surface of the front mounting portion 95 is inclined upward toward the rear when viewed from the left. The rear portion of the front mounting portion 95 is penetrated through in the left-right direction. The formation of the front mounting portion 95 reduces an extent to which the gear housing 27 covers (a front opening of) the motor housing 21.

A front engaging portion 96 protruding downward is formed at the front portion of the upper surface of the front mounting portion 95. The front engaging portion 96 is formed in the shape of a substantially triangular block, viewed from the left, and a lower surface of the front engaging portion 96 is disposed along a plane orthogonal to the up-down direction and opposite to the lower surface of the front mounting portion 95 in the up-down direction. The front engaging portion 96 is disposed one step lower to the right than the outer circumference of the gear housing 27. An engagement groove 96A is formed at a corner of the rear end of the front engaging portion 96. The engagement groove 96A is formed in the concave shape open below and rear.

An upper overhang 97 protruding downward is formed at the rear portion of the upper surface of the front mounting portion 95. The upper overhang 97 is rib-like in shape, with the left-right direction as the thickness direction and extending in the front-back direction. The upper overhang 97 is disposed one step lower to the right than the outer circumference of the gear housing 27, and a left surface of the upper overhang 97 is flush with the left surface of the front engager 96.

At the boundary between the lower end of the front mounting portion 95 and the outer circumference of the gear housing 27, a step 98 is formed that is one step lower to the right, and the step 98 extends in the front-back direction and penetrates in the front-back direction.

### Holder 84

As illustrated in FIG. 1 and FIG. 3 to FIG. 9, the holder 84 of the lighting device 80 is formed of a resin material that can transmit light. In the present embodiment, the holder 84 is configured with a transparent resin material. The holder 84 comprises a holder body 85 comprising the front portion of the holder 84 and a mounting piece 86 comprising the rear portion of the holder 84. The mounting piece 86 is assembled to the fan guide 35 and the holder body 85 is assembled to the gear housing 27.

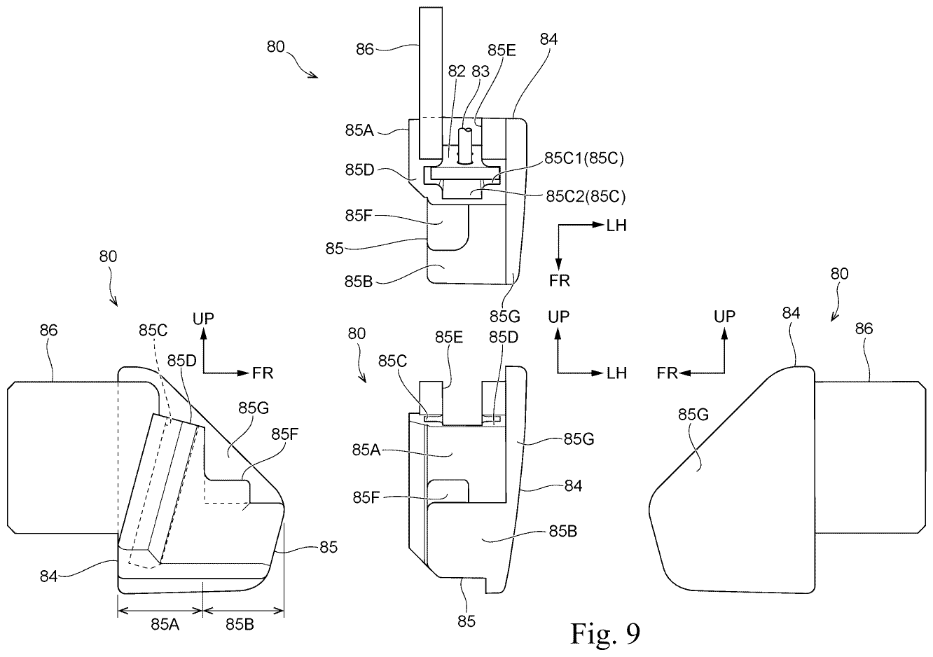

The holder body 85 is formed in a substantially L-shaped plate shape with the left-right direction as the thickness direction when viewed from the right (see FIG. 9). Specifically, the holder body 85 comprises a first base 85A that constitutes the rear portion of the holder body 85 and extends in the up-down direction, and a second base 85B that extends from the lower end of the first base 85A to the front. The first base 85A has a board holding groove 85C for holding the lighting circuit board 82 to be described further below. The board holding groove 85C extends along the direction slightly sloping toward the front toward the upper side as viewed from the left-right direction, and the upper end of the board holding groove 85C is open toward the upper side. A step 85D is formed at the front portion of the upper surface of the first base 85A, which is one step lower, and an upper opening of the board holding groove 85C is formed in the step 85D. The board holding groove 85C is formed in a substantially T-shape viewed from its longitudinal direction. Specifically, the board holding groove 85C comprises a substantially rectangular first holding groove 85C1 with the left-right direction as the longitudinal direction, and a second holding groove 85C2 protruding frontward from the center in left-right direction of the first holding groove 85C1.

In the rear end of the first base 85A, a communication groove 85E as a second groove is formed in the middle of the left-right direction to open the board holding groove 85C to the rear. The communication groove 85E is extended in the up-down direction, and the upper end of the communication groove 85E is open to the upper side.

The mounting piece 86 is formed in the substantially rectangular plate shape with the left-right direction as the thickness direction, and extends rearward from the right end of the rear surface of the holder body 85. The left surface of the mounting piece 86 is disposed flush with a right surface of the communication groove 85E. The lower end of the mounting piece 86 is inserted from the front into the rail groove 92A of the fan guide 35, and the mounting piece 86 is assembled to the fan guide 35. In an assembled state of the mounting piece 86 to the fan guide 35, the upper end of the mounting piece 86 is disposed adjacent to the right of the side wall 91B of the guide 91 of the fan guide 35, and the front end of the guide 91 is inserted into the communication groove 85E of the holder 84. In addition, in the assembled state of the mounting piece 86 to the fan guide 35, the left and right pairs of ribs 92B of the mounting rail 92 hold the mounting piece 86 from the outside in the left-right direction, and the left and right side surfaces of the communication groove 85E hold the left and right pairs of ribs 91C of the guide 91 from the outside in the left-right direction, so that a movement of the holder 84 is limited in the left-right direction. Furthermore, in a mounted state of the mounting piece 86 to the fan guide 35, the mounting piece 86 is engaged with the guide 91 and the mounting rail 92 to restrict the up-down direction and a rearward movement of the mounting piece 86. In other words, the mounting piece 86 is inserted into the rear mounting portion 90 of the fan guide 35 from the front and is engaged with the fan guide 35 in the up-down and left-right directions.

An engagement convex 85F is formed at the right end of the upper surface of the second base 85B of the holder body 85, in front of the first base 85A. The engagement convex 85F is formed in a substantially rectangular block shape and protrudes upward from the second base 85B. The holder body 85 is inserted into the front mounting portion 95 of the gear housing 27 from the rear and assembled to the gear housing 27. In the assembled state of the holder body 85 to the gear housing 27, the engagement convex 85F is inserted from the rear into the engagement groove 96A of the front mounting portion 95, and the engagement convex 85F and the engagement groove 96A are engaged in the left-right direction (see FIG. 8). In the assembled state of the holder body 85 to the gear housing 27, the holder body 85 is engaged with the front mounting portion 95 in the up-down direction to restrict the movement of the holder body 85 in the up-down direction, and the holder body 85 is sandwiched between the gear housing 27 and the motor housing 21 in the front-back direction to restrict the movement of the holder 84 in the front-back direction.

A cover 85G is formed at the left end of the holder body 85. The cover 85G is formed in a substantially trapezoidal plate shape with the left-right direction as plate thickness direction. An external shape of the cover 85G viewed from the left is formed in correspondence with the shape of the front mounting portion 95, and the upper and lower ends of the cover 85G protrude outward in the up-down direction than the first base 85A and the second base 85B. In the assembled state of the holder body 85 to the gear housing 27, the outer circumference of the cover 85G is disposed close to the left of the front engagement 96, the step 98, and the upper overhang 97 of the gear housing 27, and the cover 85G is visibly exposed from the gear housing 27 to the left. In other words, the cover 85G is configured as an exterior portion of the gear housing 27 that is exposed to the outside. The holder 84 (portion of the lighting device 80) is supported by the front mounting portion 95, which covers (closes) the portion of the motor housing 21 that was not covered by the gear housing 27. In other words, a front end opening of the motor housing 21 is configured so that the gear housing 27 and the holder 84 cooperate to close a predetermined range. The predetermined range can be all or the portion.

### Lighting Circuit Board 82

As illustrated in FIG. 8 and FIG. 9, the lighting circuit board 82 is formed in a substantially long plate shape and is housed from above within the first holding groove 85C1 of the board holding groove 85C in the holder 84, and is held in the holder 84. The LED 81 is provided on the front surface of the lighting circuit board 82, and the LED 81 is disposed within the second holding groove 85C2 of the holder 84. The LED 81 is electrically connected to the controller 50 via the lighting circuit board 82. Specifically, the wiring 83 extending from the lighting circuit board 82 passes through the communication groove 85E and is disposed on the left of the mounting piece 86 (i.e., between the guide 91 and the mounting rail 92). The wiring 83 is arranged around the periphery of the fan guide 35, extending rearward in the radial direction outside of the motor 30 and electrically connected to the controller 50. The LED 81 is configured to irradiate emitted light toward the front diagonally downward. Specifically, the light emitted by the LED 81 passes through interior of the holder body 85 and travels from a front end surface of the holder body 85 (second base 85B) to the front diagonally downward. In other words, the LED 81 and the holder body 85 irradiate the light to the front diagonally downward.

The lighting device 80 is positioned at a position that rearward than the spindle 71 and overlapping with the wheel guard 76 in the front-back direction. The lighting device 80 is disposed upper than the wheel guard 76 and lower than an axis AL of the motor 30. The lighting device 80 is disposed overlapping the spindle 71 in the up-down direction (in a range from the upper end to the lower end of the spindle 71). Furthermore, the front end of the holder 84 of the lighting device 80 is visibly exposed in the front view. This allows the light emitted by the LED 81 to irradiate the front portion of the grinding wheel 75 by irradiating the light around the lower portion of the spindle 71 from the outside in the left-right direction and the rear of the spindle 71.

### Protection Mechanism 100

The protection mechanism 100 is provided around the lighting device 80 and is configured as the mechanism to protect the lighting device 80. For example, if the left and right side surfaces of the housing 20 are placed on the ground or other flat surface, the protection mechanism 100 is designed to prevent the holder 84 of the lighting device 80, which is exposed outside of the housing 20, from contacting the ground.

Hereinafter, the protection mechanism 100 provided around the left lighting device 80 will be described first, and then the protection mechanism 100 provided around the right lighting device 80 will be described.

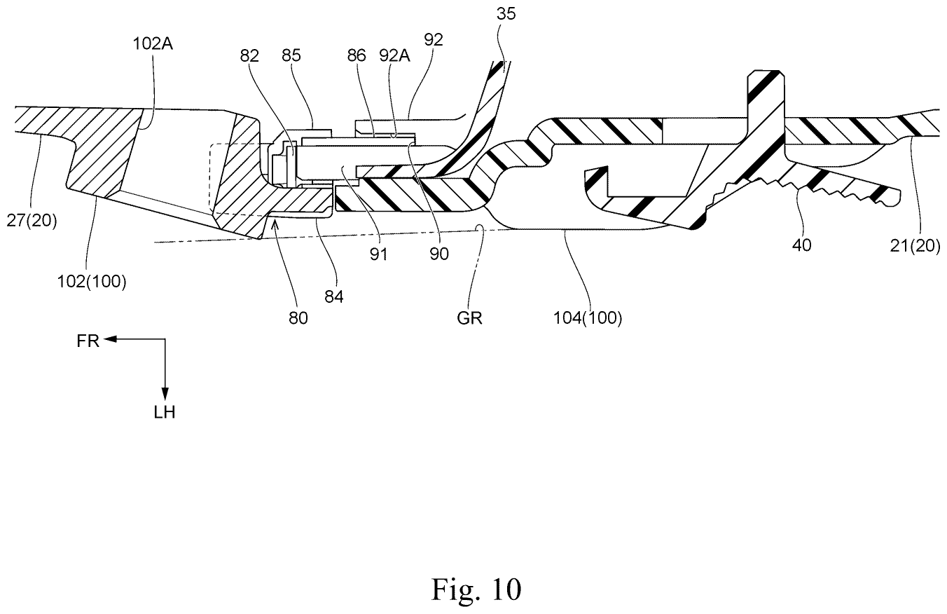

As illustrated in FIG. 10, the protection mechanism 100 comprises the handle mounting portion 102 as a front protector formed on the outer periphery of the gear housing 27 and a rear guard 104 as a pair of upper and lower rear protectors formed on the outer periphery of the motor housing 21. The handle mounting portion 102 is disposed on the front diagonally upward side of the lighting device 80. Specifically, the handle mounting portion 102 is disposed adjacent to the front of the front mounting portion 95 on the front diagonally upward side. The handle mounting portion 102 is formed in the substantially cylindrical shape along the direction that slopes toward the front as it moves toward the left, and protrude from the outer periphery of the gear housing 27 to the left. The rear end of the handle mounting portion 102 is disposed overlapping the front portion of the holder 84 in the lighting device 80 in a plan view, and protrudes to the left than the holder 84. A screw 102A is provided on an inner periphery of handle mounting portion 102, and a female screw is formed in the screw 102A. The side handle 29 (see FIG. 3 and FIG. 4) is screwed onto the screw 102A, so that the side handle 29 (auxiliary handle) is mounted to the gear housing 27. In other words, the handle mounting portion 102 is also configured as a mounter for mounting the side handle 29. The front end of the holder 84 is disposed adjacent to the lower side of the handle mounting portion 102 in the front view, and is visibly exposed.

The upper and lower pairs of rear guards 104 are ribbed with the up-down direction as the thickness direction and are disposed in close proximity to outer side of the switch lever 40 in the up-down direction. In other words, in the front-back direction, the lighting device 80 (cover 85G of the lighting device 80) is disposed between the handle mounting portion 102 and the rear guards 104. The rear guards 104 extend rearward from the diameter—expanded portion 21A of the motor housing 21, and the left end of the rear guards 104 protrude to the left than the diameter—expanded portion 21A. A lower rear guard 104 is disposed behind the lighting device 80 (cover 85G), and the handle mounting portion 102 is disposed between the upper and lower pairs of rear guards 104 in the up-down direction. In the left-right direction, the position of the left end of the rear guard 104 and the position of the rear end of the handle mounting portion 102 are substantially coincident. Therefore, when the housing 20 is placed on the flat surface such as the ground GR (see FIG. 10) with the left side down (when the left side of the housing 20 is placed in contact with the ground), the rear end of the handle mounting portion 102 and the rear guard 104 contact the ground so that the holder 84 of the lighting device 80, exposed to the outside of the housing 20, is disposed away from the ground GR to the right.

A protection mechanism 100 provided around the lighting device 80 on the right omits the rear guard 104 with respect to the protection mechanism 100 provided around the lighting device 80 on the left. In other words, the protection mechanism 100 provided around the lighting device 80 on the right consists only of the handle mounting portion 102. In the case of the lighting device 80 on the right, contact with the ground GR is configured to be made by the handle mounting portion 102 and the diameter—expanded portion 21A. In the protection mechanism 100 around the right lighting device 80, a pair of upper and lower rear guards 104 may also be provided in the motor housing 21 to make the left and right protection mechanisms 100 symmetrical.

### Effects

Next, operation and effects of the grinder 10 of the present embodiment will be described.

During machining with the grinder 10 configured as described above, the operator grips the handle 23 of the housing 20 and operates the operation dial 48 to set the rotation speed of the motor 30. Then, by sliding the switch lever 40 from the OFF position to the ON position, the switch 41 is turned on, the motor 30 is driven, and the spindle 71 and grinding wheel 75 rotate. Thus, the grinder 10 can perform polishing or other processing on the material to be processed.

The lighting device 80 is provided on both the left and right sides of the rear end of the gear housing 27, and the lighting device 80 is disposed above the wheel guard 76. Specifically, the holder 84 of the lighting device 80 is visibly exposed from the outer periphery of the gear housing 27, and the holder 84 is visibly disposed in the front view. When the LED 81 of the lighting device 80 emits light by the operator's operation of the operating portion 60, the light emitted illuminates the area around the lower portion of the spindle 71 (i.e., the grinding wheel 75). In other words, the housing 20 does not block the light irradiated from the lighting device 80 on both sides of the housing 20 toward the grinding wheel 75, and the light can illuminate the grinding wheel 75 disposed around the lower portion of the spindle 71. Thus, the lower portion of the spindle 71 (i.e., the grinding wheel 75) can be well illuminated. The lighting device 80 is configured to irradiate the light in front downward direction and is therefore exposed in the front (the front of the device is not covered). The lighting device 80 (holder 84) on the left is also exposed in left direction, and is thus configured to irradiate the light broadly to the left direction, thereby improving visibility over a wide area. The lighting device 80 on the right can similarly irradiate the light widely in right direction.

Moreover, the protection mechanism 100 is provided around the lighting device 80 to protect the lighting device 80. Specifically, the gear housing 27 is provided with the handle mounting portion 102. The handle mounting portion 102 is disposed adjacent to front diagonal upper side of the holder 84 of the lighting device 80, and the rear end of the handle mounting portion 102 protrudes outward than the lighting device 80 in the left-right direction. The rear guard 104 is provided on the left portion of the motor housing 21. The rear guard 104 is disposed behind the holder 84 of the lighting device 80 and also protrudes outwardly in the left-right direction than the lighting device 80. This means that, for example, when the left side surface of the housing 20 is placed on the flat surface such as the ground GR, the handle mounting portion 102 and the rear guard 104 contact the ground GR and the holder 84 of the lighting device 80 is disposed away from the ground GR. This allows for high protection of the lighting device 80 even when the lighting device 80 is configured to be exposed to the outside of the housing 20. In other words, when the lighting device 80 is placed on the flat surface with exposed direction down, the lighting device 80 is configured to be separated from the ground GR, thus providing high protection for the lighting device 80. In the present embodiment, the lighting device 80 disposed on the left is exposed in the left direction, but the lighting device 80 is configured so that it does not come into contact with the ground GR when it is placed on the ground GR with the left side down. In other words, even if the plane extending front-back and up-down, is brought closer to the lighting device 80 in the left-right direction, protective features (protrusions) on the housing 20 suppress contact between the lighting device 80 and the plane. Although the lighting device 80 is protected by the protruding handle mounting portion 102 and rear guard 104, respectively, in the present embodiment, the lighting device 80 may be positioned inside an outer surface (outline) of the gear housing 27 or the motor housing 21. In this way, too, the gear housing 27 or the motor housing 21 is relatively positioned outside (protruding) than the lighting device 80, which can suppress contact between the lighting device 80 and the ground GR. This configuration can protect the lighting device 80, which can be widely irradiated in the left-right direction.

As mentioned above, the handle mounting portion 102 is disposed adjacent to the front diagonal upper side of the holder 84 of the lighting device 80, and the holder 84 is partially disposed adjacent to the lower side of the handle mounting portion 102 and visibly exposed in the front view. This allows the handle mounting portion 102 to be disposed close to the front of the lighting device 80, while preventing the handle mounting portion 102 (and the side handle 29 to which it is attached) from blocking the light irradiated from the lighting device 80 toward the grinding wheel 75. In other words, since the handle mounting portion 102 is positioned above than the lighting device 80, which is configured to illuminate in front downward direction, the handle mounting portion 102 can be restrained from blocking the light irradiated from the lighting device 80 toward the grinding wheel 75. Therefore, both a lighting performance of the lighting device 80 and a protection performance for the lighting device 80 can be achieved. In addition, since the lighting device 80 is disposed outside than the accommodating portion 27D (bevel gear 74) in the left-right direction, it can be prevented from having its forward light blocked by the accommodating portion 27D. Although the light irradiated in the right direction from the lighting device 80 on the left is blocked by the accommodating portion 27D, the lighting device 80 on the right irradiates light in the right direction, so that light irradiation in the left-right direction is configured suitably.

The handle mounting portion 102 is configured as the mounter for mounting the side handle 29 to the gear housing 27. Therefore, the lighting device 80 can be protected by utilizing the handle mounting portion 102 for mounting the side handle 29 to the gear housing 27. In other words, the side handle 29 can be mounted to the gear housing 27 without affecting the lighting performance of the lighting device 80 on the grinding wheel 75.

The lighting device 80 is positioned behind the spindle 71 and outside the spindle 71 in the left-right direction, and the holder 84 of the lighting device 80 is visibly exposed from the rear end of the gear housing 27. Furthermore, the lighting device 80 is disposed in the position overlapping the spindle 71 in the up-down direction (below the upper end of the spindle 71 and above the lower end of the spindle 71). This allows the light from the lighting device 80 to be irradiated toward the grinding wheel 75 (around the spindle 71) while preventing a distance between the lighting device 80 and the grinding wheel 75 from becoming longer. In addition, by providing the lighting device 80 at the rear end of the gear housing 27, the need to place the wiring 83 extending from the lighting device 80 in the gear housing 27, which houses the transmission mechanism such as the spindle 71, is reduced. This can improve workability when assembling the lighting device 80. As a result, the grinding wheel 75 can be illuminated even better while improving the workability when assembling the lighting device 80.

In the lighting device 80, the mounting piece 86 of the holder 84 is assembled to the fan guide 35 (inner member) housed in the motor housing 21 and assembled to the motor 30, and the holder body 85 of the holder 84 is assembled to the gear housing 27. Therefore, the lighting device 80 can be assembled to the housing 20 by assembling the gear housing 27 to the motor housing 21 with the lighting device 80 temporarily assembled to the fan guide 35. Thus, one end side of the lighting device 80 in the front-back direction is supported by the motor housing 21 and other end side is supported by the gear housing 27. In this way, the lighting device 80 is supported at two points in the front-back direction, which firmly supports the lighting device 80 and prevents the lighting device 80 from wobbling. If the lighting device 80 wobbles, dust may enter through the gaps, so firmly supporting the lighting device 80 is also effective in ensuring airtightness. In the grinder 10, since the fan guide 35 is a particularly large diameter member, it is important to provide the lighting device 80 (LED 81) forward than the fan guide 35, which is ideally addressed by making the fan guide 35 a support member for the lighting device 80. The inner member does not have to be the fan guide 35. For example, it can be configured to be assembled to an insulator of the motor 30, which is also a circular member. In the grinder 10, the fan guide 35 is positioned immediately behind the gear housing 27 and is used as a support for the lighting device 80, but another member may be configured to support the lighting device 80 as the inner member if they are similarly positioned.

In the assembled state of the lighting device 80 to the housing 20, the holder 84 (holder body 85) of the lighting device 80 is sandwiched in the front-back direction by the front mounting portion 95 of the gear housing 27 and the front end of the motor housing 21. This allows the lighting device 80 to be assembled to the housing 20 by mounting the gear housing 27 to the motor housing 21, which houses the motor 30, from the front, as described above. In other words, assembling the gear housing 27 to the motor housing 21 enables positioning of the lighting device 80 (in particular, restricting the movement in the forward and left-right directions), which makes assembly easier.

The lower end of the mounting piece 86 of the holder 84 in the lighting device 80 is inserted from the front into the rail groove 92A of the fan guide 35, and the rail groove 92A and the mounting piece 86 are engaged in the left-right direction. This allows the lighting device 80 to be assembled to the fan guide 35 by inserting the mounting piece 86 into the rail groove 92A of the fan guide 35. This allows the lighting device 80 to be assembled to the fan guide 35 with a simplified configuration while improving an ease of assembly of the lighting device 80 to the fan guide 35. The holder body 85 comprises the second base 85B extending forward from the first base 85A that holds the LED 81. The light of the LED 81 is then irradiated forward from the front end of the second base 85B. With this configuration, a light irradiation opening can be easily changed by adjusting the position of the LED 81. Thus, by extending the second base 85B a little further forward, the range of forward light illumination can be adjusted.

The guide 91 is formed in the fan guide 35, and the guide 91 is disposed adjacent to the upper end of the mounting piece 86 of the holder 84 in outward direction in the left-right direction. This allows the guide 91 to guide the mounting piece 86 of the holder 84 when it is inserted into the fan guide 35. Thus, the ease of assembly of the holder 84 to the fan guide 35 can be further improved. The communication groove 85E is formed in the holder 84, and the front end of the guide 91 is inserted into the communication groove 85E to engage the guide 91 and the holder 84 in the left-right direction. As a result, the holder 84 is engaged with the fan guide 35 at the two upper and lower portions. Therefore, the holder 84 can maintain a good assembled state to the fan guide 35.

In the lighting device 80, the wiring 83 extending from the lighting circuit board 82 is disposed outside the mounting piece 86 in the left-right direction. In other words, the wiring 83 is disposed between the guide 91 of the fan guide 35 and the mounting rail 92. This allows a wiring arrangement status of the wires extending from the lighting circuit board 82 to the rear to be well maintained by the guide 91 and mounting rail 92, and to be routed to the controller 50 at the rear.

The gear housing 27 has the front mounting portion 95 into which the holder body 85 of the holder 84 is inserted, and the front mounter is groove-shaped and open to the front and outward in the left-right direction. This allows the light emitted by the LED 81 to be irradiated from the front end of the holder 84, while the holder body 85 is covered from both sides in the up-down direction by an inner circumference of the front mounting portion 95. Thus, the holder 84 can be protected from both sides in the up-down direction by the gear housing 27 while ensuring the lighting performance of the lighting device 80. The front mounting portion 95 is groove-shaped and is configured to insert the portion of the lighting device 80 through the front end opening of the motor housing 21. In other words, the front end opening of the motor housing 21 is closed by the gear housing 27 and holder 84 working together, so the motor housing 21 can maintain its conventional shape. The front mounting portion 95 does not necessarily have to be open in the left-right direction. For example, the front mounting portion 95 need only be configured to allow insertability of the holder 84 in the front-back direction and may be a through hole in the front-back direction. In this case, the holder 84 will be at least partially covered by the gear housing 27 in the left-right direction, thereby improving protection for the holder 84. In this case, the opening of the through hole in the front-back direction allows the lighting device 80 to be visible in the front-back direction, so that the light can be suitably irradiated to the front.

The engagement groove 96A is formed in the front mounting portion 95 of the gear housing 27, and the engagement convex 85F of the holder 84 is inserted into the engagement groove 96A to engage the gear housing 27 and the holder 84 in the left-right direction. This allows the holder 84 (lighting device 80) to maintain the good assembled state to the gear housing 27.

### Lighting Device 80 Arrangement: Variation 1

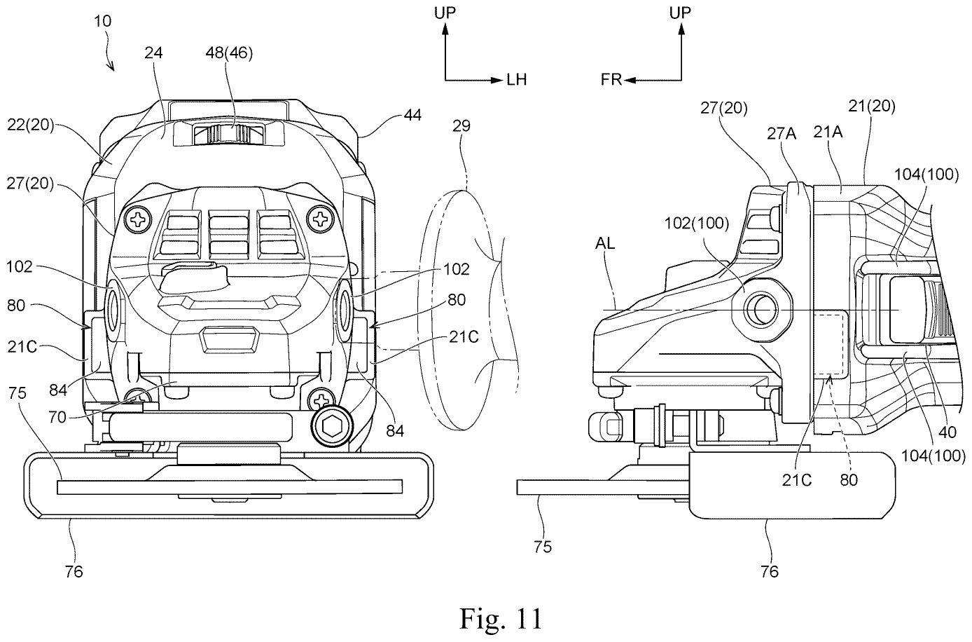

Next, variation 1 of the arrangement of the lighting device 80 is described using FIG. 11. As illustrated in the figure, in variation 1 of the arrangement of the lighting device 80, the lighting device 80 is provided on both the left and right sides of the front end of the motor housing 21. Specifically, a cover 21C is formed at the front end of the motor housing 21, projecting outward in the left-right direction and open to the front. The lighting device 80 is provided inside the cover 21C. In other words, the front end opening of the motor housing 21 is larger than in the first embodiment because of the formation of the cover 21C. Even if the gear housing 27 does not have the front mounting portion 95 (recess), the cover 21C cannot be closed, but instead the lighting device 80 covers the cover 21C. As a result, the gear housing 27 and the lighting device 80 cooperate to close the front end opening of the motor housing 21 as in the first embodiment.

The lighting device 80 is disposed above the wheel guard 76 and below the axis AL of the motor 30, as well as overlapping the spindle 71 in the up-down direction, as in the present embodiment. When viewed from the front, the holder 84 of the lighting device 80 is disposed outside in the left-right direction and below the handle mounting portion 102 and is exposed for visibility.

The light emitted by the LED 81 (not illustrated) of the lighting device 80 is irradiated from the front end surface of the holder 84 to the front diagonally downward, and the light illuminates the area around the lower portion of the spindle 71 (i.e., the grinding wheel 75). This means that also in variation 1, the housing 20 does not block the light irradiated toward the grinding wheel 75 from the lighting device 80 provided on both sides of the housing 20, and the grinding wheel 75 disposed around the lower portion of the spindle 71 can be illuminated by the light.

In variation 1, the lighting device 80 is positioned rearward and outside in the left-right direction than the spindle 71, and the holder 84 of the lighting device 80 is visibly exposed from the front end of the motor housing 21. In other words, the lighting device 80 is provided on both sides of the housing 20, visible from the front through a forward opening (cover 21C) provided at the housing 20, and is disposed in the position overlapping the wheel guard 76 in the front-back direction. Therefore, also in variation 1, it is no longer necessary to place the wiring 83 extending from the lighting device 80 in the gear housing 27 that houses the transmission mechanism such as the spindle 71, while suppressing the increase in a separation distance between the lighting device 80 and the grinding wheel 75. As a result, also in variation 1, the grinding wheel 75 can be illuminated even better while improving the workability during assembly of the lighting device 80.

In variation 1, the holder 84 of the lighting device 80 is covered by the cover 21C of the motor housing 21. This improves the protection of the lighting device 80.

### Lighting Device 80 Arrangement: Variation 2

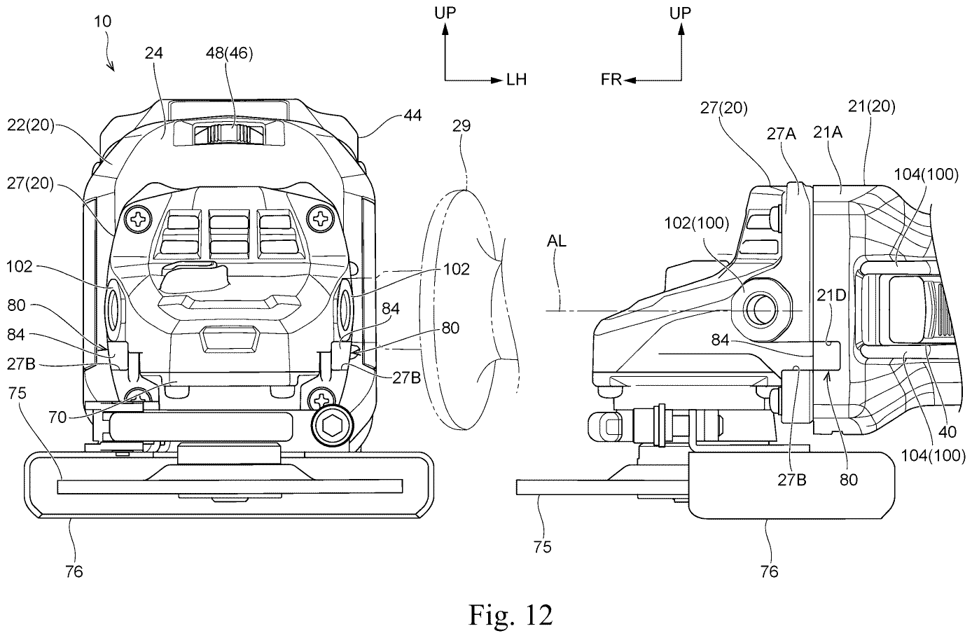

Next, variation 2 of the arrangement of the lighting device 80 is described using FIG. 12. As illustrated in the figure, in variation 2 of the arrangement of the lighting device 80, the lighting device 80 is provided on both the left and right sides of the front end of the motor housing 21. Specifically, an exposed portion 21D is formed on the side of the front end of the motor housing 21 to expose the lighting device 80, and the exposed portion 21D is notched in the concave shape open to the front. On the outer periphery of the gear housing 27, a groove 27B is formed on the front of the exposed portion 21D, extending in the front-back direction and open to the outside in the left-right direction. The groove 27B penetrates in the front-back direction, and the groove 27B exposes the front end of the holder 84 of the lighting device 80, which is visible in the front view.

The lighting device 80 is disposed above the wheel guard 76 and below the axis AL of the motor 30, as well as overlapping the spindle 71 in the up-down direction, as in the present embodiment. When viewed from the front, the holder 84 of the lighting device 80 is disposed below the handle mounting portion 102 and is exposed for visibility.

The light emitted by the LED 81 (not illustrated) of the lighting device 80 is irradiated from the front end surface of the holder 84 to the front diagonally downward side, and the light illuminates the area around the lower portion of the spindle 71 (i.e., the grindstone 75). This means that also in variation 2, the housing 20 does not block the light irradiated toward the grinding wheel 75 from the lighting device 80 provided on both sides of the housing 20, and the grinding wheel 75 disposed around the lower portion of the spindle 71 can be illuminated by the light.

In variation 2, the lighting device 80 is positioned rearward and outside in the left-right direction than the spindle 71, and the holder 84 of the lighting device 80 is visibly exposed from the front end of the motor housing 21. In other words, the lighting device 80 is provided on both sides of the housing 20 and disposed in the position that overlaps the wheel guard 76 in the front-back direction. Therefore, also in variation 2, it is no longer necessary to place the wiring 83 extending from the lighting device 80 in the gear housing 27 that houses the transmission mechanism such as the spindle 71, while suppressing the increase in the separation distance between the lighting device 80 and the grinding wheel 75. As a result, in variation 2, the grinding wheel 75 can be illuminated even better while improving the workability during assembly of the lighting device 80. In addition, Variation 2 can be realized with a simple configuration since there is no need to provide a structure to support the lighting device 80 on the gear housing 27 side.

Also in variation 2, the lighting device 80 is disposed between the handle mounting portion 102 and the rear guard 104. This allows the lighting device 80 to be protected by the protection mechanism 100.

### Lighting Device 80 Arrangement: Variation 3

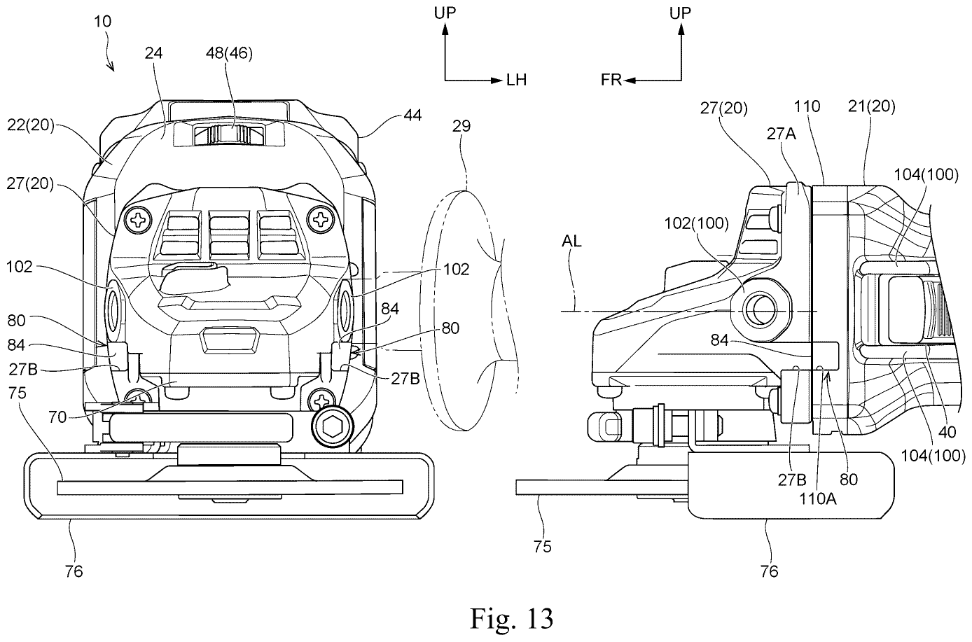

Next, variation 3 of the arrangement of the lighting device 80 is described using FIG. 13. As illustrated in the figure, in variation 3 of the arrangement of the lighting device 80, the front end of the motor housing 21 in the grinder 10 is configured with a frame-shaped spacer 110, and the lighting device 80 is provided on the left and right sides of the spacer 110. Specifically, an exposed portion 110A is formed on the side of the spacer 110 to expose the lighting device 80, and the exposed portion 110A is notched in the concave shape open to the front, similar to the exposed portion 21D in variation 2. On the outer periphery of the gear housing 27, as in variation 2, the groove 27B that extends in the front-back direction and is open to the outside in the left-right direction is formed on the front of the exposed portion 110A. The groove 27B penetrates in the front-back direction, and the groove 27B exposes the front end of the holder 84 of the lighting device 80, which is visible in the front view.

The lighting device 80 is disposed above the wheel guard 76 and below the axis AL of the motor 30, as well as overlapping the spindle 71 in the up-down direction, as in the present embodiment. When viewed from the front, the holder 84 of the lighting device 80 is disposed below the handle mounting portion 102 and is exposed for visibility.

The light emitted by the LED 81 (not illustrated) of the lighting device 80 is irradiated from the front end surface of the holder 84 to the front diagonally downward side, and the light illuminates the area around the lower portion of the spindle 71 (i.e., the grindstone 75). This means that also in variation 3, the housing 20 does not block the light irradiated toward the grinding wheel 75 from the lighting device 80 provided on both sides of the housing 20, and the grinding wheel 75 disposed around the lower portion of the spindle 71 can be illuminated by the light.

In variation 3, the lighting device 80 is positioned rearward and outward in the left-right direction than the spindle 71, and the holder 84 of the lighting device 80 is visibly exposed through the spacer 110 between the motor housing 21 and gear housing 27. In other words, the lighting device 80 is provided on both sides of the housing 20 and disposed in the position that overlaps the wheel guard 76 in the front-back direction. Therefore, also in variation 3, it is no longer necessary to place the wiring 83 extending from the lighting device 80 in the gear housing 27 that houses the transmission mechanism such as the spindle 71, while suppressing the increase in the separation distance between the lighting device 80 and the grinding wheel 75. As a result, in variation 3, the grinding wheel 75 can be illuminated even better while improving the workability during assembly of the lighting device 80.

Also in variation 3, the lighting device 80 is disposed between the handle mounting portion 102 and the rear guard 104. This allows the lighting device 80 to be protected by the protection mechanism 100. Although variation 3 is characterized in that the lighting device 80 is held by the spacer 110 to be added, a holding structure may be similar to variation 1, where the lighting device 80 is held by the cover that protrudes to the left and right. In this way, the lighting device 80 can be implemented without changing the shapes of the motor housing 21 and the gear housing 27 (without providing cutouts, and so on).

### Lighting Device 80 Arrangement: Variation 4

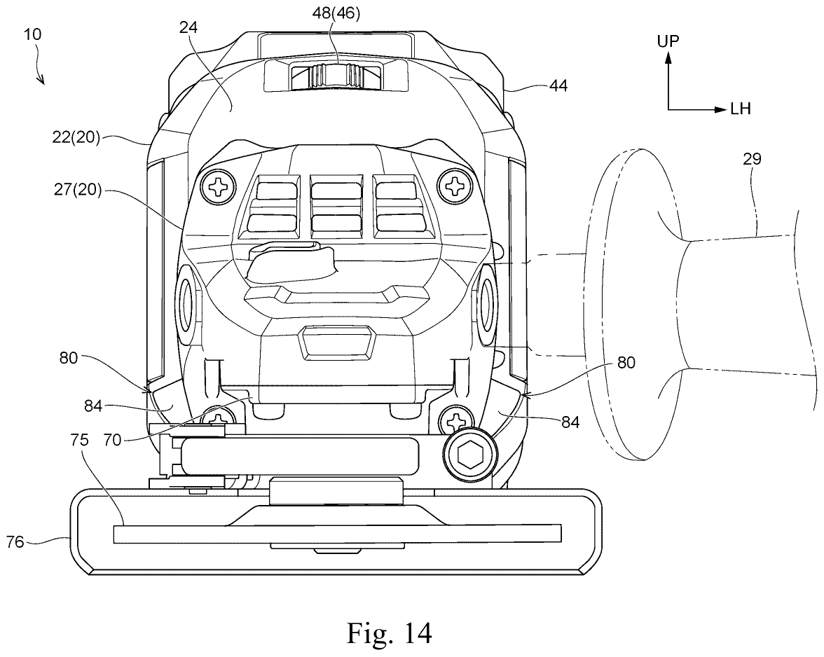

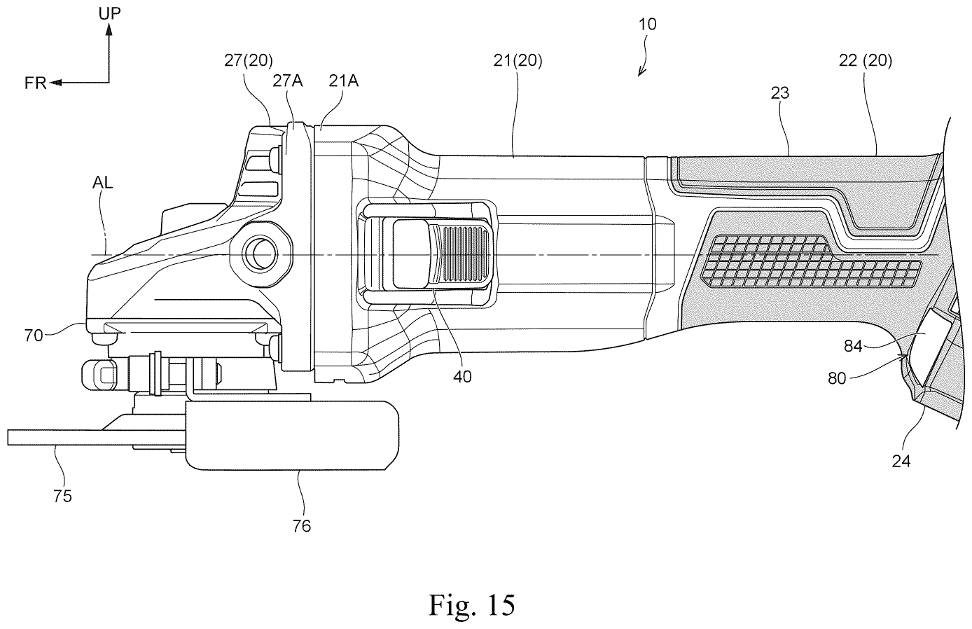

Next, variation 4 of the arrangement of the lighting device 80 is described using FIG. 14 and FIG. 15. As illustrated in the figures, in variation 4 of the arrangement of the lighting devices 80, a pair of left and right lighting devices 80 are provided at the lower end of the rear housing 24 in the handle housing 22.

The lighting device 80 is disposed above the wheel guard 76 and below the axis AL of the motor 30 in side view, and disposed in the position that overlaps the spindle 71 in the up-down direction. When viewed from the front, the holder 84 of the lighting device 80 is disposed outside in the left-right direction of the lower end of the gear housing 27 and is also visibly exposed (see FIG. 14).

The light emitted by the LED 81 (not illustrated) of the lighting device 80 is irradiated from frontward the front end surface of the holder 84, and the light illuminates the area around the lower portion of the spindle 71 (i.e., the grindstone 75). This means that also in variation 4, the housing 20 does not block the light irradiated toward the grinding wheel 75 from the lighting device 80 provided on both sides of the housing 20, and the grinding wheel 75 disposed around the lower portion of the spindle 71 can be illuminated by the light.

In the first embodiment, the lighting device 80 is provided on each of the left and right sides of the housing 20, but the lighting device 80 may be configured to be provided on one of the left and right sides of the housing 20.

In the first embodiment, the rear portion of the holder 84 of the lighting device 80 is assembled to the fan guide 35, but the rear portion of the holder 84 may be configured to be assembled to the front end of the motor housing 21.

### Second Embodiment

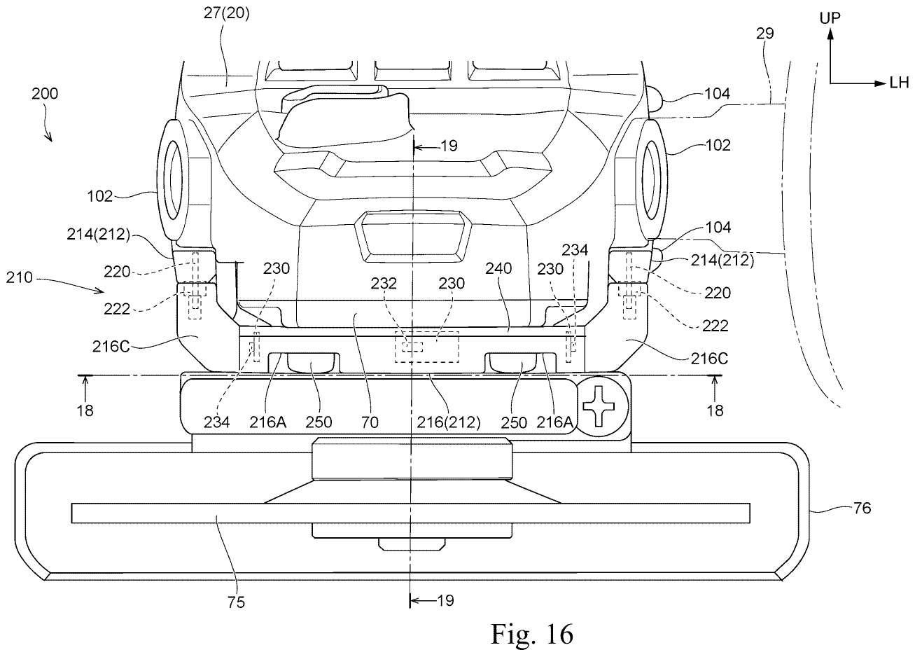

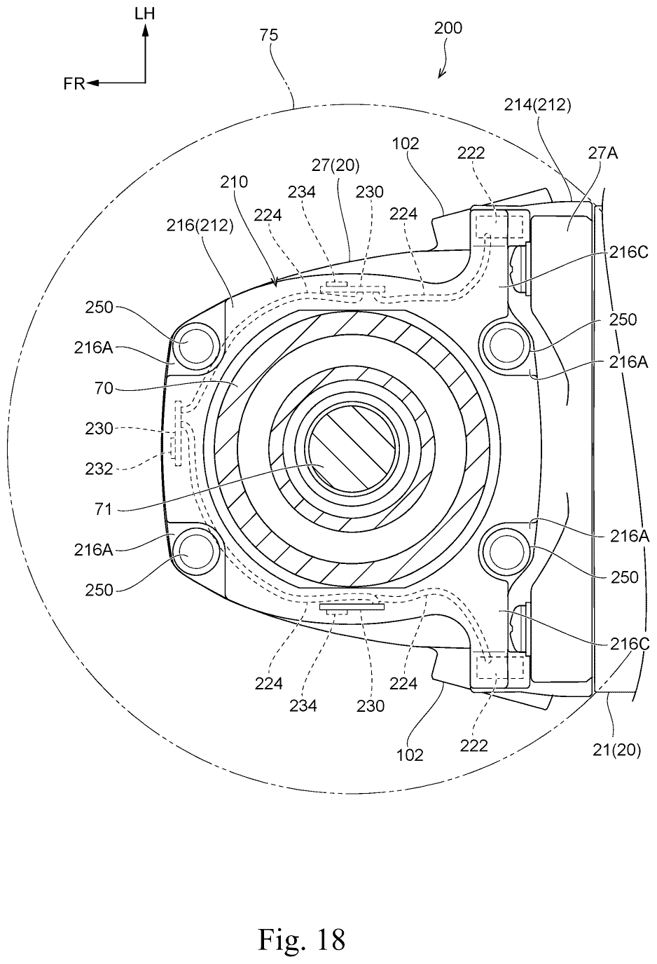

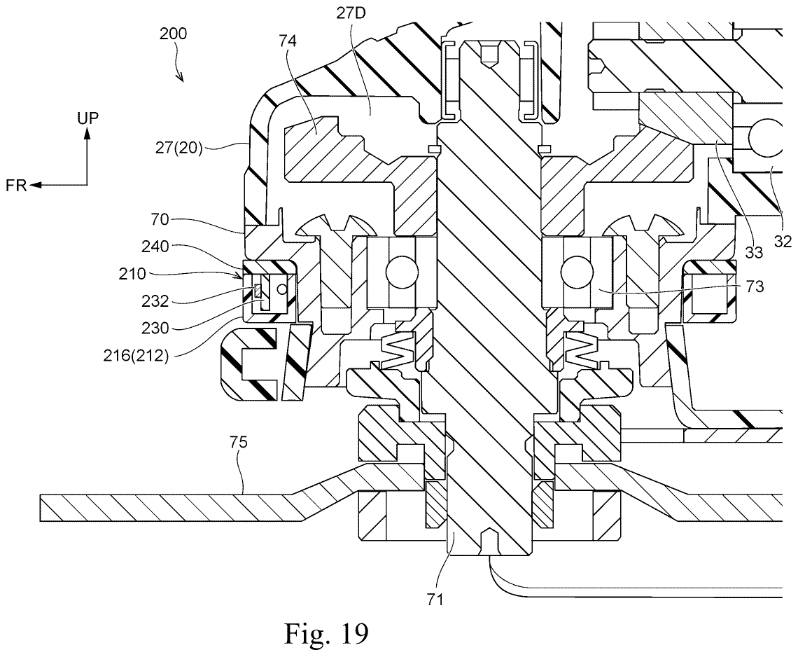

Next, a disk grinder 200 (hereinafter simply referred to as a grinder 200) as a working machine of a second embodiment will be described using FIG. 16 to FIG. 20. The present embodiment can also be called variation 5 in a sense that an arrangement of a lighting device is different, but since there are many differences from a first embodiment, it will be described as the second embodiment of the invention. The grinder 200 of the second embodiment is configured in a same manner as a grinder 10 according to the first embodiment, except for the points illustrated below. In FIG. 16 to FIG. 20, parts similarly configured to the grinder 10 according to the first embodiment are marked with same symbols.

In the grinder 200, a lighting device 210 is provided in a housing 20 instead of a lighting device 80. The lighting device 210 has a holder 212, which constitutes the outline (at least a portion of the outline) of the lighting device 210 as well as a member that houses and holds LED 232 and LED 234 and so on, described further below. The holder 212 comprises a pair of right and left relay holders 214 as a second holder and a transparent holder 216 as a first holder. The lighting device 210 also has a holder cover 240 that covers the transparent holder 216 from top.

The pair of relay holders 214 are made of resin. The pair of relay holders 214 are configured in a substantially similar manner to a holder 84 in the first embodiment, and a rear portion of the relay holders 214 are assembled to a rear mounting portion 90 of a fan guide 35 (not illustrated). In other words, the relay holders 214 are located outside than a spindle 71 in left-right direction. A front portion of the relay holders 214 protrude forward from both ends in the left-right direction of a diameter—expanded portion 21A of a motor housing 21 as a first housing and is disposed in a front mounting portion 95 of a gear housing 27. The relay holders 214 are sandwiched from both sides in front-back direction by a front edge of the diameter—expanded portion 21A of the motor housing 21 and the front mounting portion 95 of the gear housing 27 to restrict a movement in the front-back direction. A front end of the relay holders 214 protrude forward to be disposed below a handle mounting portion 102.

Although the figure is omitted, also in the second embodiment, when the housing is placed on a flat surface such as a ground with a left side surface down, a rear end of the handle mounting portion 102 and a rear guard 104 contact the ground, so that the relay holders 214 are disposed away from the ground, and so on, to right.

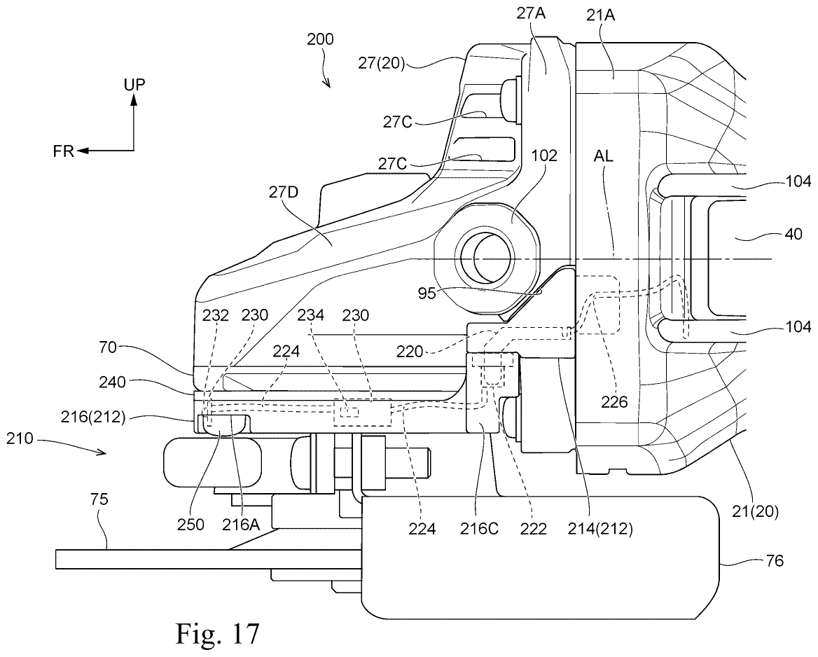

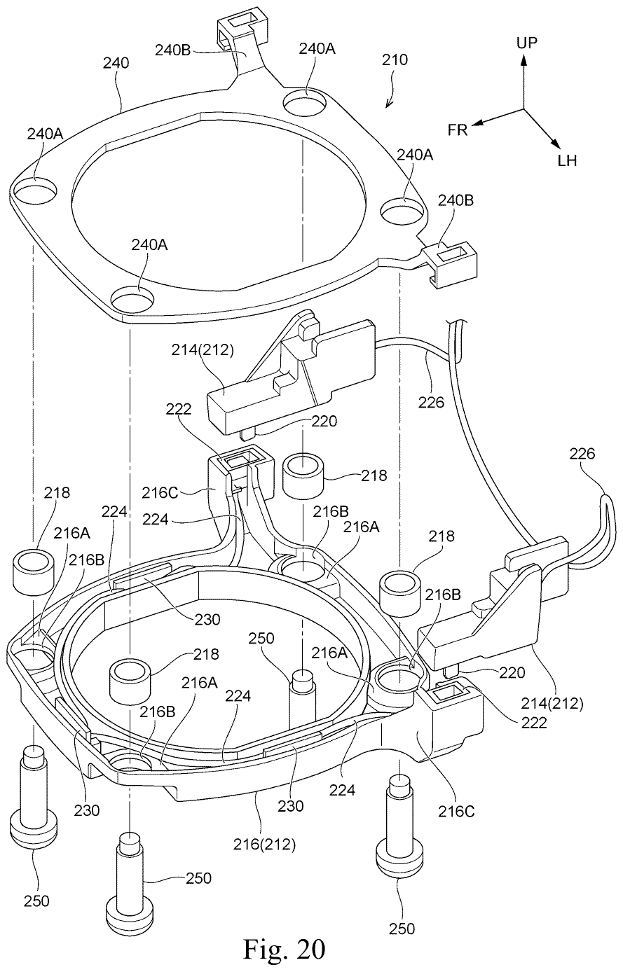

Terminal 220 (see FIG. 16 and FIG. 17) is embedded in the front portion of the relay holders 214. The terminal 220 are extended in the front-back direction, and the front end of the terminal 220 bend downward and protrude downward from the front end of the relay holders 214. A wiring 226 (see FIG. 17 and FIG. 20) is connected to the rear ends of the terminal 220. The wiring 226 extends rearward from the terminal 220 and is electrically connected to a controller 50.

The transparent holder 216, like the holder 84 of the first embodiment, is configured with a resin material that can transmit light (transparent resin material). The transparent holder 216 is provided below an upper end of a packing gland 70 and radial direction outside of a middle in up-down direction of the packing gland 70, and is fastened to the gear housing 27 together with the holder cover 240 and the packing gland 70 described further below. In other words, the transparent holder 216 is positioned lower than the gear housing 27 and the relay holders 214.

The transparent holder 216 is formed as a whole in a substantially circular shape and is concave, open to upper side. When the transparent holder 216 is fixed to the gear housing 27, the middle of the packing gland 70 in the up-down direction is disposed in the transparent holder 216. In other words, the transparent holder 216 is disposed along circumferential direction of the packing gland 70 so as to surround the middle of the packing gland 70 in the up-down direction in the radial direction outside of the spindle 71, and is visibly exposed from both the front and the left-right direction. The transparent holder 216 is positioned above than a grinding wheel 75 and a wheel guard 76. In the second embodiment, the gear housing 27 and the packing gland 70 are a second housing of the present invention, and the gear housing 27 and the packing gland 70 correspond to split members of the present invention, respectively.

A pair of left and right fixing part 216A are formed at the front and rear ends of the transparent holder 216, respectively. The fixing part 216A are disposed in a position one step upward relative to a bottom surface of the transparent holder 216. A fixing hole 216B (see FIG. 20) is formed through the fixing part 216A in the up-down direction. The transparent holder 216 is provided with metal sleeves 218 (see FIG. 20) at the position corresponding to the fixing parts 216A. The sleeve 218 is formed in a substantially cylindrical shape with the up-down direction as axis direction. The lower end of the sleeve 218 is fitted into the fixing hole 216B, and the sleeve 218 protrudes upwardly from the fixing part 216A. The transparent holder 216 is disposed below the upper end of the packing gland 70, a fixing screw 250 as a fixture is inserted from below into the sleeve 218, and the transparent holder 216 is fastened and fixed to the gear housing 27 with the packing gland 70 by the fixing screw 250. An outer shape of the transparent holder 216 is set so that the holder 212 does not protrude from the gear housing 27 in a plan view when the transparent holder 216 is fixed to the gear housing 27.

At the rear end of the transparent holder 216, a pair of relay couplings 216C are provided. The relay coupling 216C extend outward from the transparent holder 216 in the left-right direction at the position rearward than the spindle 71, and the middle of the relay coupling 216C in longitudinal direction are bent upward. A tip of the relay coupling 216C is disposed adjacent to the lower front end of the relay holders 214. A connector 222 is provided within the tip of the relay couplings 216C, and the front end of the terminals 220 are connected to the connector 222.

Three lighting boards 230 are housed in the transparent holder 216. One lighting board 230 is disposed in a center in the left-right direction at the front end of the transparent holder 216 with the front-back direction as thickness direction, and is held in the transparent holder 216. An LED 232 as a light source is provided on a front surface of the lighting board 230. The LED 232 is positioned forward than the spindle 71 and also irradiates emitted light frontward. The LED 232 is disposed in the position overlapping the spindle 71 when viewed from the front, and the gear housing 27 when viewed from the top.

Other two lighting boards 230 are disposed respectively within the middle in the front-back direction at the left and right ends of the transparent holder 216 with the left-right direction as the thickness direction, and are held in the transparent holder 216. The LEDs 234 as the light sources are provided on outer side surfaces in the left-right direction of the left and right lighting boards 230. The LEDs 234 are positioned outward than the spindle 71 in the left-right direction and also irradiate the emitted light to the outside in the left-right direction. The LEDs 234 are disposed in the position overlapping the spindle 71 when viewed from the left-right direction, and the gear housing 27 when viewed from the top. The lighting board 230 and the LED 232, and the lighting board 230 and the LEDs 234 correspond to a light-emitter of the present invention.

The LED 232 and the LED 234 are connected in series and to connector 222 by a wiring 224 arranged in the transparent holder 216. As a result, the LED 232 and the LED 234 are electrically connected to the controller 50. Under a control of the controller 50, a power is supplied to the LED 232 and the LED 234 from a battery 44 (power supply), causing the LED 232 and the LED 234 to emit the light. The terminal 220, the connector 222, and the wiring 224 correspond to a connecting portion of the present invention.

A holder cover 240 is formed in a substantially circular plate shape with the up-down direction as plate thickness direction, and a shape of the holder cover 240 corresponds to the outer shape of the transparent holder 216. The holder cover 240 is sandwiched in the up-down direction by the holder 212 and the packing gland 70, with an opening of the holder 212 being closed by the holder cover 240. The holder cover 240 has an insertion hole 240A through which the upper end of the sleeve 218 is inserted. Furthermore, a coupling cover 240B corresponding to the relay coupling 216C is formed at the rear end of the holder cover 240. The connection cover 240B extends outward from the holder cover 240 in the left-right direction and bends upward. The above-mentioned connector 222 is held at the tip of the connection cover 240B.

As described above, in the second embodiment, the light emitted by the LED 232 of the lighting device 210 passes through the transparent holder 216 and irradiated frontward from a front end surface of the transparent holder 216, illuminating an area around a frontward periphery of a lower portion of the spindle 71 (i.e., grinding wheel 75) by the light. The light emitted by the LED 234 of the lighting device 210 passes through the transparent holder 216 and is irradiated from left and right side surfaces of the transparent holder 216 to the outside in the left-right direction, illuminating the area on both sides in the left-right direction around the lower portion of the spindle 71 (i.e., the grinding wheel 75) by the light. As a result, also in the second embodiment, the housing 20 does not block the light irradiated from the lighting device 210 provided in the housing 20 toward the grinding wheel 75, and the light can illuminate the grinding wheel 75 disposed around the area of the lower portion of the spindle 71.

In the lighting device 210 of the second embodiment, the transparent holder 216 holding the LEDs 232 and 234 is disposed around the spindle 71 in the radial direction outside of the spindle 71. Therefore, the LEDs 232 and 234 can be disposed at any position in the radial direction outside of the spindle 71 to illuminate the grinding wheel 75 disposed around the lower portion of the spindle 71. The LEDs 232 and 234 irradiate the light emitted toward the radial direction outside of the spindle 71 (front or left-right direction outside). Therefore, the light emitted from the LEDs 232 and 234 is prevented from being blocked by the spindle 71. Therefore, the area around the grinding wheel 75 can be effectively illuminated.

In particular, in the second embodiment, the LED 232 is positioned forward than the spindle 71, so when machining using the front portion of the grinding wheel 75, a front area of the grinding wheel 75 can be effectively illuminated. Also, since the LED 234 is positioned outside of spindle 71 in the left-right direction, it can effectively illuminate both sides of grinding wheel 75 in the left-right direction when machining using the left-right direction outer edge of grinding wheel 75. This can further effectively improve workability of the grinder 200.

The transparent holder 216 is disposed to enclose the middle of the packing gland 70 in the up-down direction from the radial direction outside and is positioned above the grinding wheel 75. Furthermore, the LED 232 and the LED 234 overlap the gear housing 27 when viewed from the top. This allows the LEDs 232 and 234 to effectively illuminate the area around the grinding wheel 75 while suppressing the enlargement of the transparent holder 216.

In the second embodiment of the lighting device 210, the holder 212 has the relay holder 214 and the transparent holder 216. The relay holder 214 is assembled to the fan guide 35, and a rearward movement of the relay holder 214 is regulated by the motor housing 21 and a frontward movement of the relay holder 214 is regulated by the gear housing 27. This allows the relay holder 214 to be fixed to the housing 20 with a simple configuration. The transparent holder 216 is disposed below the gear housing 27 and is fixed to the gear housing 27 together with the packing gland 70 by the fixing screw 250. This allows the transparent holder 216 to be fixed to the gear housing 27 while reducing an increase in the number of parts. Positioning the transparent holder 216 below the gear housing 27 eliminates a need for the wiring 224 for connecting the LEDs 232 and 234 to be places in the gear housing 27, which houses a transmission mechanism, such as the spindle 71. This allows for good illumination around the grinding wheel 75 while improving the workability when assembling the transparent holder 216.

The transparent holder 216 is disposed below the upper end of the packing gland 70 and surrounds the middle of the packing gland 70 in the up-down direction, and the outer shape of the transparent holder 216 is set so that the transparent holder 216 does not protrude than the gear housing 27 when viewed from the top. This allows the LEDs 232 and 234 to be disposed in the radial direction outside of the spindle 71 while suppressing an overall body size enlargement of the grinder 200.

In the second embodiment, the terminal 220 is held by the relay holder 214 and the terminal 220 is connected to the connector 222 to electrically connect the controller 50 to the LED 232 and LED 234, but the method of connecting the controller 50 to the LED 232 and LED 234 are not limited to this. For example, a board having a relay connector or the like that is connected to the connector 222 may be held by the relay holder 214 to electrically hold the controller 50 and the LEDs 232 and 234.

### DESCRIPTION OF REFERENCE NUMERALS

10: Disc grinder (working machine)
20: Housing
21: Motor housing (first housing)
27: Gear housing (second housing, split member)
30: Motor
35: fan guide (inner member)
44: Battery (power supply)
70: Packing gland (second housing, split member)
71: Spindle
75: Grinding wheel (tip tool)
76: Wheel guard (guard member)
80: Lighting device
81: LED (light source)
82: Lighting board
83: Wiring
84: Holder
85E: Communication groove (second groove)
86: Mounting piece (rear portion of holder)
91: Guide
92A: Rail groove (first groove)
950: Protection mechanism
102: Handle mounting portion (front protector)
104: Rear guard (rear protector)
200: Disk grinder (working machine)
210: Lighting device
212: Holder
214: Relay holder (second holder)
216: Transparent holder (first holder)
220: Terminal (connecting portion)
222: Connector (connecting portion)
224: Wiring (connecting portion)
232: LED (light source)
234: LED (light source)
250: fixing screw (fixture)

1. A working machine comprising:
a motor that rotates with front-back direction as its axis;
a housing with a motor housing that houses the motor and a gear housing that is disposed on front of the motor housing;
a spindle supported by the gear housing, extending in up-down direction, rotating by transmission of a driving force of the motor, and to which a disc-shaped tip tool is removably attached at a lower portion;
a guard member attached to the gear housing and covering at least a portion of the tip tool; and
a lighting device that is at least partially provided above the guard member and on at least one of left and right sides of the housing, and that extends from inside of the motor housing so as to extend outside of the gear housing, and irradiates light around the lower portion of the spindle.

2. A working machine comprising:
a motor that rotates with front-back direction as its axis;
a housing with a motor housing that houses the motor and a gear housing that is disposed on front of the motor housing;
a spindle supported by the gear housing, extending in up-down direction, rotating by transmission of a driving force of the motor, and to which a disc-shaped tip tool is removably attached at a lower portion;
a guard member attached to the gear housing and covering at least a portion of the tip tool; and
a lighting device that is provided lower than an axis of the motor and illuminates an area around the lower portion of the spindle;
wherein, the lighting device is at least partially provided above the guard member and on at least one of left and right sides of the housing, and the lighting device is visible from the front of the housing through a space created by a forward opening or a left-right recess set in the housing.

3. The working machine according to claim 1,
wherein the working machine comprises a protection mechanism that prevents contact between a flat surface such as a ground or a floor and the lighting device when the lighting device is brought close to the flat surface in left-right direction.

4. The working machine according to claim 3,
wherein the lighting device is configured to be visible when viewed from the front, and the protection mechanism is configured to protrude the outside of the housing than the lighting device.

5. The working machine according to claim 4,
wherein the protection mechanism is configured with:
a front protector disposed adjacent to the front of the lighting device; and
a rear protector disposed at rear of the lighting device;
wherein the lighting device is partially disposed on lower side of the front protector.

6. The working machine according to claim 1,
wherein the lighting device is positioned above than the tip tool and behind and outside in left-right direction than the spindle.

7. The working machine according to claim 6,
wherein the lighting device is visibly exposed from an outer circumference of left and right sides of the gear housing.

8. The working machine according to claim 7,
wherein the lighting device comprises:
a light emitter having a light source; and
a holder holding the light emitter,
wherein a rear portion of the holder is connected to the motor housing or an inner member housed in the motor housing, and a front portion of the holder is connected to the gear housing.

9. The working machine according to claim 8,
wherein the rear portion of the holder is assembled to the inner member which is assembled to the motor, and the holder is sandwiched in the front-back direction by the gear housing and the motor housing.

10. A working machine comprising:
a motor that rotates with front-back direction as its axis;
a housing with a motor housing that houses the motor and a gear housing that is disposed on front of the motor housing;
a spindle supported by the gear housing, extending in up-down direction, rotating by transmission of a driving force of the motor, and to which a disc-shaped tip tool is removably attached at a lower portion;
a guard member attached to the gear housing and covering at least a portion of the tip tool;
a handle mounting portion provided at the gear housing to which a side handle that can be grasped by an operator can be mounted; and
a lighting device having a light emitter positioned above the guard member and below the handle mounting portion, and the light emitter irradiates light around the lower portion of the spindle.

11. The working machine according to claim 10,
wherein the light emitter is disposed outside of the first motor housing.

12. The working machine according to claim 10,
wherein the lighting device has a connecting portion connecting a power supply supplying power to the light emitter and the light emitter, and a holder that holds the light emitter and the connecting portion,
wherein the holder holds the light emitter at a position forward than the spindle.

13. The working machine according to claim 12,
wherein the holder is disposed to surround the spindle and comprises a first holder that holds the light emitter and the connecting portion, and a second holder that holds the connecting portion,
wherein a rear portion of the second holder is housed inside the motor housing, and a front portion of the second holder protrudes forward through the motor housing provided at a front end of the motor housing and is sandwiched front to back by the motor housing and the gear housing.

14. The working machine according to claim 13,
wherein the first holder is disposed radially outward of the spindle with respect to a lower end of the gear housing and above the tip tool,
wherein the light emitter overlaps the gear housing when viewed from top.

15. The working machine according to claim 13,
wherein the gear housing is configured with at least two or more split members,
wherein the first holder is fixed to the gear housing by a fixture that fixes the split members together.
